(19) United States
(12) Patent Application Publication
(10) Pub. No.: US 2023/0040088 A1
(43) Pub. Date: Feb. 9, 2023

(54) METHOD FOR OBTAINING NITRATE-BASED EUTETIC MIXTURES TO THERMAL STORAGE IN SOLAR COOLING SYSTEMS AND SUCH EUTETIC MIXTURES

(71) Applicant: UNIVERSIDAD DE ANTOFAGASTA, Antofagasta (CL)

(72) Inventors: Svetlana Nikolaevna USHAK DE GRAGEDA, Antofagasta (CL); Mario Sandro GRAGEDA ZEGARRA, Antofagasta (CL); Jorge Alfredo LOVERA COPA, Antofagasta (CL); Mariela Cecilia VEGA PANOZO, Antofagasta (CL)

(21) Appl. No.: 17/597,070

(22) PCT Filed: Dec. 23, 2020
(86) PCT No.: PCT/CL2020/050192

§ 371 Date: Dec. 23, 2021

(51) Int. Cl. C09K 5/06

(52) U.S. Cl. CPC C09K 5/063

(57) ABSTRACT

The present invention is related to a method for obtaining nitrate-based eutectic mixtures based on a BET model to thermal storage of solar refrigeration systems within the range of temperature from 0 to 15° C. Mixtures based on the following hydrate salts: LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, having melting points of 10.8, −1.1, 13.1, 12.0 and 7.1° C., respectively. Thermal and physical properties were established such as the heat of crystallization/melting, calorific capacity to solid and liquid phases, viscosity, density and change of volume during the mixture of eutectic mixtures. The results of energy storing density (esd) varied from 238.3 to 304.5 MJ·m⁻³. The phase changing material (PCM) being more potent to be used in solar energy-assisted air conditioning systems (AC) is LiNO₃—NaNO₃—Mn(NO₃)₂—H₂O.

### FIELD OF THE INVENTION

The present invention is related to phase changing materials (PMC) to be applied in refrigeration systems or solar energy-assisted air conditioning (AC) systems using cool water storing tanks and then the same requires efficient systems within such range of temperature. These PMCs correspond to quaternary eutectic mixtures based on inorganic salts. Quaternary mixtures or eutectic mixtures are obtained from a modified BET model with its respective melting temperatures, phase composition and diagram to be used into 2 tanks of 5000 L each one and were tested in an AC system where the same showed adequately and advantageously functioning. From 10 quaternary mixtures having expected eutectic properties: LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiCl—LiNO₃—LiClO₄—H₂O, LiNO₃—NH₄NO₃—Ca(NO₃)₂—H₂O, LiNO₃—NaNO₃—Ca(NO₃)₂—H₂O, NH₄NO₃—Mn(NO₃)₂—Mg(NO₃)₂—H₂O, NaNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, only 5 of them resulted as advantageous: LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, having melting temperatures of 10.8, −1.1, 13.1, 12.0 and 7.1° C., respectively. Being the LiNO₃—NaNO₃—Mn(NO₃)₂—H₂O and LiNO₃—Mn(NO₃)₂—Mg(NO₃)₂—H₂O mixtures the most adequate ones.

### ANTECEDENTS

Solar energy in form of solar radiation is compatible with almost any type of life in the earth. Solar light is the major energy source to the earth surface which can be used by means several processes as natural as well synthetic.

All energy form is from solar origin. Oil, carbon, natural gas and wood were originally produced by means of photosynthetic processes followed by complex chemical reactions wherein the vegetation in decomposition was submitted to very high temperatures and pressures during a long period of time. Even, the wind and tidal energies have a solar origin since the same are caused by difference of temperature in several regions of the earth.

The energy has been used by human beings to facilitate tasks and can be classified in 2 groups: conventional energy or non-renewable energy or renewable energy called as well free or green energy.

Non-renewable energy can be found in the nature under limited quantity. The type of energy can not be renewable at short term and as consequence the same is running out with use. In the present, this is the major energy source. The same is present in form of carbon, oil, natural gas or uranium. However, traditional techniques of energy generation have damaging effects to the environment and, thus, at international level, countries have decided implementing generation techniques which are more respectful with environment from renewable sources.

At worldwide level in the field of renewable energy resources and systems, researching and development have been carried out during the last two decades. Energy conversion systems based on renewable energy techniques seems to be profitable compared to the high cost projected to the oil. Further, renewable energy systems can have a benefic impact in the environmental, economic and political problems of the world. At the end of 2001 year, the capacity installed of renewable energy system was 9% of the total electrical generation. Applied a scenario of intensive use of renewable energy, the global consumption of renewables sources to 2050 would achieve 318 EJ.

Nations leading the energetic transition from a use of global clean energy are the developing nations. This fact remarks a notable change respect of investments from a decade when the richest countries of the world represented the main part of the renewable energy investment.

Investments to provide energy have suffered a modification in the last years in relation to the preference of non-renewable energies to renewable energies. Energy coming from sun made is way, being the major investment, with 69 GW in 2017 year at worldwide level.

The manufacture of water solar heaters started at the beginning of the sixties. The industry of water solar easily spread in many countries of the world.

There are many ways to keep spaces as refrigerated. Since the dawn of mankind, shade, solar orientation and other designs have been used in order to keep the interior of buildings cool.

Active conditioning air (AC) is a relatively recent phenomenon. However, the techniques are developed within the century XIX. The widespread AC use started in the 50's. The AC's design, in the present, depends on the size of the building, can be from a room to a group of buildings, and from the supplier source either electricity, natural gas or solar energy.

The conditioning of buildings is the use of energy having the main growing between 1990 and 2016 years. The total use of electricity for cooling in the whole world arose to 2000 TWh in 2016 year, about of 10% of the 21000 TWh of the globally consumed electricity in all the sectors by this year.

Along to the next three decades, the use of AC is estimated as to be very relevant, becoming in one of the main boosters of the world electricity demand. Improving the efficiency and the same time keeping the thermal comfort to the population can be the key to avoid the challenge of a “cooling crisis”.

There is no doubt in that one of the most serious problems of the modem world is the climatic change and its negative important consequences to the environment. Human activity, particularly the energy consumption to industrial use has been considered as one of the main factors contributing to climatic change in the last decades. To cope with the futures changes in the environment, among others measures, is essential a change of the current technologies to generate energy. Traditional techniques of generation such as carbon burning have damaging effects to the environment and then, at international level, countries have turned to techniques of generation more respectful with the environment from the renewable sources such as solar and wind energy.

Another significant factor is the increasing of electricity associated to the use of AC and fans to keep fresh, which already represents approximately a fifth part of the total of the electricity used in buildings of all the world, or the current 10% of the whole worldwide electricity consumption. But as incomes and living standards improve in many developing countries, the AC demand growth in warmer regions will skyrocket. AC use is expected to be the second largest source of growth in global electricity demand after the industrial sector, and the strongest driver for buildings in 2050.

The increasing use of AC in homes and offices around the world will be one of the main drivers of electricity demand globally for the next three decades, according to a new analysis by the International Energy Agency (IEA) that highlights the urgent need for policy measures to improve cooling efficiency. The solar energy solution is to link AC with thermal energy storage systems (TES).

TES systems have great expectations to solve environmental energy problems and favor the industrial-scale implementation of solar energy. These systems can store heat or cold for later use in various conditions such as temperature or location, being one of the most powerful alternatives to improve the energy efficiency of buildings. The TES presents phase change materials (PCM) as an option to increase the thermal mass of building envelopes and systems due to the latent heat produced during the phase change.

The physical and thermal properties of inorganic Phase Change Materials (PCM) make them attractive to be used as PCM in the efficient conditioning of buildings. For this application it is necessary to find PCMs with low melting temperatures, lower than room temperature.

Theoretically, by combining two or more hydrated salts, eutectic mixtures can be formed, with melting points below the melting temperature of the pure components.

Currently, the use of sustainable renewable energy for heating and cooling is very low compared to its high potential. The strengths of renewable energy sources are sustainability and local availability. Unfortunately, due to the local diversity of sources and technologies used it is impossible to build massive markets for Renewable Heating and Cooling (RHC). For this reason, simple policy instruments are insufficient to stimulate the deployment of Renewable Heating and Cooling (RHC) technologies in markets.

The cooling of spaces consumes energy that comes, mostly, from fossil fuels, this contributes to the increase in CO₂ emissions. The impact of CO₂ emissions can be reduced by implementing solar-assisted cooling systems.

Thermal Energy Storage (TES) allows to store heat and cold to be used later in different temperature or place conditions. The TES can assist in the efficient use and provision of thermal energy in the event of a mismatch, in terms of time, temperature, power or site, between generation and use of energy.

The benefits that can be obtained through the implementation of the thermal storage system are: better economic aspects, higher efficiency, less environmental pollution and less CO₂ emissions, better performance and efficiency and greater reliability of the system.

In the design of TES systems, the following requirements must be considered: high energy storage density in the storage material, heat transfer between the heat transfer fluid (HTF) and the storage material, mechanical and chemical stability of the storage material, compatibility between the storage material and the packaging material, complete reversibility of a number of cycles, low thermal losses during the storage period and easy control.

The entire TES process involves three steps: loading, storing, and unloading. Heat or cold supplied by a heat source is transferred to heat storage, stored in storage, and then transferred to a heat sink to meet demand.

All applications establish a series of boundary conditions, which must be carefully examined: 1) The supply temperature at the source must be greater than or equal to the storage temperature. 2) The amount of heat transferred in a certain time must be that required in loading and unloading. 3) In some applications, Heat Transfer Fluid (HTF) and movement by free or forced convection must be considered. 4) The classification of thermal storage systems is divided into active storage and passive storage.

An active storage system is characterized by forced convection heat transfer in the storage material. The storage material circulates through a heat exchanger, a solar receiver or a steam generator. This system uses one or two tanks as storage media. The direct active storage system uses HTF as the storage medium to store heat. While the indirect active storage system requires, in addition to HTF, a second medium to store heat.

Passive systems are those systems that capture and use solar energy without the use of external devices but rather use natural physical means for their operation, such as a solar fireplace to improve the ventilation of a home, they do not require additional energy to function, they do not emit greenhouse gases and its operating cost is zero, so its maintenance cost is very low.

There are three types of thermal energy storage: sensible heat thermal energy storage (SHTES), thermochemical thermal energy storage, and latent heat thermal energy storage (LHTES).

One definition of Heat Sensitive Thermal Energy (SHTES) storage materials is that they do not change phase with temperature change in a heat storage process. The amount of energy involved in a specific heat storage process depends on the specific heat of the material. Some disadvantages are inherent to the system. The most important of them, its relative low energy density and self-discharge, which can be decisive when long periods of storage are intended.

SHTES in buildings has been extensively investigated and can be divided into two groups: liquid and solid storage media. Liquids are more often limited to water, and solids are stones, bricks, concrete, iron, dry and wet earth, among others.

Water has been widely used for heat storage, as well as for transporting heat in power systems. It appears to be the best of the sensible heat storage liquids for temperatures below 100° C. due to its availability, its minimal cost and, most importantly, its relatively high specific heat. For a temperature change of 70° C. (20° C.-90° C.), water can store 290 MJ·m⁻³. It is also the most widely used storage medium for solar hot water and space heating applications.

Solid media are widely used for low temperature storage. They are made up of rocks, concrete, sand, bricks, among others. The materials most commonly used in buildings for the storage of solar heat are in fact those that intervene in the structure of the building. For solar heat storage in construction applications, solid materials are mostly used for heating and cooling purposes. Its operating temperatures cover a wide range, from 10 to more than 70° C. The main drawback to using solids as heat storage materials is their low specific heat capacity (˜1200 kJ·m⁻³·K⁻¹ on average), which results in a relatively low energy density. However, compared to liquid materials, two main advantages are inherent to solid materials: their viability at higher temperatures, and the absence of leakage in their containment. The compatibility of the material with the HTF used is important. Furthermore, the efficiency and feasibility of solid materials heat storage systems are strongly dependent on the solid material size and shape, HTF type and flow pattern.

Thermochemical energy storage is produced when the chemical reaction is used to store energy. Only reversible reactions can be used because the reaction products must be able to store energy (endothermic reaction) and the stored heat must be able to be obtained when the reverse reaction occurs (exothermic reaction).

Thermochemical energy storage is divided between chemical reactions and adsorption systems. In chemical reactions, high energy storage density and reversibility of materials are required. Generally, chemical energy conversion has better efficiency in energy storage performance than physical methods (sensible and latent heat storage). The most important challenge is finding the right reversible chemical reaction for the energy source used. The main reactions studied for use in thermochemical storage media are the carbonation reaction, the decomposition of ammonia, the metal oxidation reactions, the hydration reactions and the sulfur cycles.

Materials used in Latent Heat Thermal Energy Storage (LHTES) systems are called PCM. A PCM is a material that changes phase at a certain temperature. The phase change can occur during the following changes in the physical state of the material: solid-liquid, solid-solid, gas-solid, liquid-gas, and vice versa. During the phase change process, a PCM absorbs or releases a large amount of heat in order to carry out the transformation. This action is known as the melting or vaporization latent heat. The melting heat is transferred to the material, storing large amounts of heat at constant temperature; heat is released when the material solidifies and energy is released through this process. The PCMs used can be organic, inorganic or eutectic materials. Usually, the phase change from solid to liquid, by melting and solidification is used.

There are several properties of PCMs, such as physical, thermal, chemical and kinetic, in addition to cost, availability, product safety, including health risk and toxicity, which are important due to environmental and social impact.

To select a PCM, the physical properties must also be considered. Examples of this are congruent melting and negligible volume changes during phase transformations. The chemical properties that are studied are chemical stability, reversible melting/crystallization cycle, that is not corrosive, toxic, explosive or flammable. Both high latent heat and energy storage density are preferred when selecting a PCM.

LHTES systems have some advantages over SHTES systems. LHTES have a high bulk density and an operating temperature that is relatively constant for PCM systems, but varies widely for SHTES systems. As shown in Table 1, for the same amount of stored heat, LHTES systems using paraffin, 1.5 times (or 3 times) less volume is needed than sensible heat storage systems with water (or rocks), with a temperature change of 50° C. However, there are some disadvantages associated with LHTES materials. These are: low thermal conductivity, low material stability over several cycles, phase segregation, subcooling, and high cost.

Table 1 Comparison of different heat storage media (for sensible heat storage, energy is stored in the temperature range 25-75° C.).

TABLE 1

| | Heat Storage Materials | | | |
|---|---|---|---|---|
| | SHTES Materials | | SHES Materials | |
| Properties | Stone | Stone | Stone | Stone |
| Latent melting Heat (kJ · kg⁻¹) | — | — | 174.4 | 266 |
| Specific heat (kJ · kg⁻¹ · K⁻¹) | 0.9 | 4.18 | — | — |
| Density (kg · m⁻¹) at 24° C. | 2240 | 1000 | 1802 | 795 |
| Relative Volume^{a} | 3.1 | 1.5 | 1.0 | 1.5 |

^{a}Equivalent storing volume; paraffin taken as reference

PCMs can be classified in the following main categories: organic PCMs, inorganic PCMs and eutectic PCMs. In turn, organic PCMs can be classified into paraffins and non-paraffins (fatty acids, esters and alcohols). The Norwegian PCMs in salts/hydrates and metals. Eutectic PCMs in Organic-Organic, Organic-Inorganic, Inorganic-Inorganic. Each of these groups has its typical range of melting temperature and melting enthalpy.

The advantages of organic compounds are the ability to melt congruently, that they freeze without too much subcooling, their own nucleating properties, compatibility with conventional construction materials, they do not present segregation, they are chemically stable, they have high melting heat, they are safe and non-reactive and recyclable. Disadvantages of organic compounds are low thermal conductivity in their solid state, they are flammable, and to obtain reliable phase change points, most manufacturers use technical grade paraffins that are essentially mixtures of paraffin and are completely refined from oil, resulting in high costs.

The most studied inorganic PCMs include salt hydrates, salt compounds, and metal alloys. The advantages of inorganic compounds are high latent heat storage capacity, availability and low cost, precise melting point, high thermal conductivity, high melting heat, and they are non-flammable. The disadvantages of inorganic compounds are the volume change is very high, the sub-cooling, the nucleating agents can disintegrate or suffer some damage. Inorganic compounds that have a potential behavior as PCM. See Table 2. While hydrated salts that have potential behavior to be used as PCM. See Table 3.

TABLE 2
Inorganic compounds with potential use as PCMs.

| | Melting Point | Melting Heat |
|---|---|---|
| Compound | (° C.) | (J/g) |
| AlCl₃ | 192 | 280 |
| LiNO₃ | 250 | 370 |
| NaNO₃ | 307 | 172 |
| KNO₃ | 333 | 266 |
| Na₂O₂ | 360 | 314 |
| KOH | 380 | 150 |
| KClO₄ | 527 | 1253 |
| LiH | 699 | 2678 |
| MgCl₂ | 714 | 452 |
| NaCl | 800 | 492 |
| Na₂CO₃ | 854 | 276 |
| KF | 857 | 452 |
| LiF | 868 | 932 |
| K₂CO₃ | 897 | 235 |
| NaF | 993 | 750 |
| MgF₂ | 1271 | 936 |

TABLE 3
Hydrated salts with potential use as PCMs.

| | Tmelting/ | ΔH/ | k/(W · m⁻¹ · K⁻¹) | | ρsolid/ |
|---|---|---|---|---|---|
| Compound | (° C.) | (J · g⁻¹) | Liquid | Solid | (10³ kg · m⁻³) |
| LiClO₃•3H₂O | 8 | 253 | — | — | — |
| KF•4H₂O | 18.5-19 | 231 | — | — | 1.45 |
| Mn(NO₃)₂•6H₂O | 25.3 | 125.9 | — | — | — |
| CaCl₂•6H₂O | 28.0-30.0 | 190-200 | 0.540 | 1.088 | 1.80 |
| LiNO₃•3H₂O | 30 | 256 | — | — | — |
| Na₂SO₄•10H₂O | 34 | 256 | — | — | — |
| Na₂CO₃•10H₂O | 33 | 247 | — | — | — |
| NaCH₃COO•3H₂O | 55.6-56.5 | 237-243 | — | — | — |
| CaBr₂•6H₂O | 34 | 115.5 | — | — | 2.19 |
| Na₂HPO₄•12H₂O | 35-45 | 179.6 | 0.476 | 0,.514 | 1.52 |
| Zn(NO₃)₂•6H₂O | 36 | 146.9 | 0.464 | — | — |
| Zn(NO₃)₂•4H₂O | 45.5 | — | — | — | — |
| Zn(NO₃)₂•2H₂O | 54 | — | — | — | — |
| Na₂S₂O₃•5H₂O | 48-55 | 201 | — | — | 1.75 |
| Na(CH₃COO)•3H₂O | 58 | 226 | — | — | 1.45 |
| Cd(NO₃)₂•4H₂O | 59.5 | — | — | — | — |
| Na₂B₄O₇•10H₂O | 68.1 | — | — | — | — |
| Na₃PO₄•12H₂O | 69.0 | — | — | — | — |
| Na₂P₂O₇•10H₂O | 70 | 184 | — | — | — |
| Ba(OH)₂•8H₂O | 78 | 266 | — | — | — |
| (NH₄)Al(SO₄)₂•12H₂O | 95 | 269 | — | — | — |
| MgCl₂•6H₂O | 117 | 169 | — | — | — |
| Mg(NO₃)₂•6H₂O | 89.3 | 150 | — | — | — |

Eutectic PCMs are organic-organic, organic-inorganic, inorganic-inorganic compounds. They are mixtures of two or more components with a single melting or vaporization point lower than that corresponding to each of the compounds in its pure state. The change of state, at constant pressure, takes place at constant temperature as in the case of pure compounds. The advantages of eutectic compounds are the precise melting points, similar to pure substances and the storage bulk density is slightly higher than that of organic compounds. The disadvantages of eutectic compounds are the limited data on thermo-physical properties because the use of these materials is relatively new for thermal storage applications.

The various mixtures for low and high temperature applications that have been considered as possible PCM are shown in Table 4. The thermophysical properties are presented, such as melting point, melting heat and density.

TABLE 4
Eutectic and Non-Eutectic mixtures with potential use as PCMs.

| | | ΔHm/ | ρliq/ |
|---|---|---|---|
| Eutectic Mixtures | Tm/(° C.) | (J · g⁻¹) | (kg · m⁻³) |
| 45% CaCl₂•6H₂O + 55% CaBr₂•6H₂O | 14.7 | 140 | — |
| 66.6% CaCl₂•6H₂O + 33.3% MgCl₂•6H₂O | 25 | 127 | — |
| 50% CaCl₂ + 50% MgCl₂•6H₂O | 25 | 95 | — |
| 48% CaCl₂ + 4.3% NaCl + 0.4% KCl + 47.3% H₂O | 27 | 188 | — |
| 47% Ca(NO₃)₂•4H₂O + 53% Mg(NO₃)₂•6H₂O | 30 | 136 | — |
| 40% CH₃COONa•3H₂O + 60% NH₂CONH₂ | 30 | 200.5 | — |
| 50% Na₂SO₄•10H₂O + 50% NaCl | 18 | — | — |
| 61.5% Mg(NO₃)₂•6H₂O + 38.5% NH₄NO₃ | 52 | 125 | — |
| 58.7% Mg(NO₃)₂•6H₂O + 41.3% MgCl₂•6H₂O | 59 | 132 | — |
| 53% Mg(NO₃)₂•6H₂O + 47% Al(NO₃)₂•9H₂O | 61 | 148 | — |
| 59% Mg(NO₃)₂•6H₂O + 41% MgBr₂•6H2O | 66 | 168 | — |
| 14% LiNO₃ + 86% Mg(NO₃)₂•6H₂O | 72 | 180 | — |
| 66.6% urea + 33.4% NH4Br | 76 | 161 | — |
| 11.8% NaF + 54.3% KF + 26.6% LiF + 7.3% MgF₂ | 449 | — | 2160 |
| 35.1% LiF + 38.4% NaF + 26.5% CaF₂ | 615 | — | 2225 |
| 32.5% LiF + 50.5% NaF + 17.0% MgF₂ | 632 | — | 2105 |
| 51.8% NaF + 34.0% CaF₂ + 14.2% MgF₂ | 645 | — | 2370 |
| 48.1% LiF + 51.9% NaF | 652 | — | 1930 |
| 63.8% KF + 27.9% NaF + 8.3% MgF₂ | 685 | — | 2090 |
| 45.8% LiF + 54.2% MgF₂ | 746 | — | 2305 |
| 53.6% NaF + 28.6% MgF₂ + 17.8% KF | 809 | — | 2110 |
| 66.9% NaF + 33.1% MgF₂ | 832 | — | 2190 |
| Mezclas no-eutécticas | | | |
| H₂O + poliacrilamida | 0 | 292 | — |
| 50% Na(CH₃COO)•3H₂O + 50% HCONH₂ | 40 | 255 | — |

To evaluate the suitability of a PCM for a particular application and in a specific temperature range, the thermophysical properties must be taken into account. The properties that must be met for most applications, but not for all applications, are: 1) The temperature of the PCM must be adequate to ensure storage and heat extraction in the application to which it is designated. 2) High phase change enthalpy to achieve high energy storage density compared to SHTES. 3) The material must take into account a thermal conductivity that matches a particular application. 4) Reproducible phase change to use the PCM several times, without presenting phase segregation allowing a large number of cycles. 5) Little sub-cooling to ensure melting and solidification are carried out at the same temperature. 6) Low vapor pressure to reduce mechanical stability requirements in a vessel containing the PCM. 7) Small volume change to reduce mechanical stability requirements in a vessel containing the PCM. 8) Chemical and physical stability to ensure long PCM life. 9) Compatibility with the other materials that make up the system to guarantee a long useful life of the container that contains the PCM and the surrounding materials in case of leakage. 10) That it is not toxic, polluting or explosive for environmental and safety reasons. 11) Recyclability for environmental and economic reasons. Usually a material cannot meet all the requirements mentioned above. However, some properties can be improved.

Within the group of inorganic PCMs, hydrated salts are promising materials that meet most of the aforementioned requirements. However, these present certain difficulties when using them in practical applications, which are mentioned below.

Incongruent Fusion, Phase Separation: Most hydrated salts melt with decomposition as the temperature increases, forming water and hydrated salt at the bottom. This process is called incongruous fusion. Hydrated salt sinks because its density is greater than that of water. Therefore, only the upper part of the salt recrystallizes in the cooling process. Inconsistent melting is an irreversible process and can significantly reduce storage efficiency. As a result, the substance separates into its two components at the end of each heating/cooling cycle.

Subcooling: When some molten salts are cooled, they solidify at a temperature below the melting point. The reason for the subcooling is because the nucleation rate or the growth rate of the nuclei or both are slow. Subcooling reduces the storage capacity of the PCM, modifies the operating temperature of the PCM, decreasing heat recovery.

Subcooling only occurs during solidification. During subcooling, latent heat will not be released when the phase change temperature is reached. Instead, the temperature of the material will gradually decrease until a point is reached such that crystallization begins. If crystallization does not occur, latent heat will be trapped in the material and therefore the material only stores sensible heat. Therefore, subcooling poses a significant challenge in PCM storage applications. Subcooling will reduce the efficiency of the cooling system. Subcooling can be overcome by the addition of a nucleating agent. Nucleating agents can be used as nuclei of PCM crystals to grow in them during the freezing process. Another method to avoid sub-cooling is the cold finger technique. A nucleating device is kept colder than the maximum subcooling temperature.

Insufficient Long-Term Stability: Insufficient long-term stability of storage materials and containers is a problem that has limited the widespread use of latent heat storage. This is due to the poor stability of the PCMs and the corrosion between the PCM and the containers. Appropriate PCMs must be capable of performing a large number of melt and freeze cycles without degrading their properties. In addition, PCMs must be compatible with the materials that contain them.

Low Thermal Conductivity and Heat Transfer Rate: Most high-density PCMs have relatively low thermal conductivity. This requires the use of techniques to improve the appropriate heat transfer in latent heat thermal storage. During a phase change process for freezing, the phase change begins at the heat transfer surface, causing the solid/liquid boundary of the PCMs to move away from the heat transfer surface. This phase change of the PCMs acts as an insulator, reducing the heat transfer of the HTF, thus increasing the thermal resistance. Heat transfer through solid PCM is exclusively by conduction and due to its low thermal conductivity; the heat transfer rate within the PCM is low.

Regarding the characterization techniques, the techniques to determine the melting latent heat in PCMs are by means of differential scanning calorimetry (DSC) and the temperature history method (T-history).

Differential Scanning Calorimetry (DSC) is a thermo-analytical technique, where a material is cooled and heated isothermally and the transition events are investigated as a function of time or temperature against a standard reference. The DSC determines the transition temperatures and enthalpy changes in solids and liquids under a controlled temperature change. The DSC equipment generates a rapid analysis for research and quality control tasks, being able to cover temperatures from −180° C. to 700° C.

Typical applications of DSC are to determine parameters and properties such as: Melt crystallization, Phase diagrams, Liquid crystal transitions, Eutectic purity, Solid-liquid ratio, Solid-solid transitions, Specific heat, Oxidative stability, among other applications. Typical applications of DSC are to determine parameters and properties such as: Melt crystallization, Phase diagrams, Liquid crystal transitions, Eutectic purity, Solid-liquid ratio, Solid-solid transitions, Specific heat, Stability The sample must be prepared and encapsulated before entering the DSC sample tray. The empty micro-crucible (Aluminum 40 μL) is weighed, the sample is added into the micro-crucible, the micro-crucible is hermetically sealed with the sealing press. Using sealed crucibles prevents the degradation of hydrated salts. The best reference material is to use the same type of empty micro-crucible. Both micro-crucibles are placed inside the oxidative equipment, among other applications.

The crystallization and melting latent heat is absorbed or released by the material when the phase change occurs without temperature change in the sample. The encapsulated sample is cooled or heated from the initial temperature, passing through the phase change temperature, remains in the isotherm for a short period of time before heating or cooling down to the initial temperature. Melting and crystallization heats can be calculated using the DSC data analysis program.

The characteristics of PCMs make it difficult to determine the properties, such as subcooling, hysteresis and crystallization problems among others. Additionally, DSC results can be influenced by sample mass and heating/cooling rate.

On the other hand, the T-history method is a technique to evaluate the thermophysical properties of PCMs. Developed in 1998, the T-history method investigates the temperature history of a sample in relation to a reference material. In addition, it evaluates the melting point, latent heat of fusion, degree of subcooling, specific heat, and thermal conductivity of multiple samples simultaneously. The T-history method has the ability to evaluate large sample amounts, optimized measurement time, and simple construction.

The method consists of putting PCM in the test tubes, one or more, and a reference, usually water due to its known thermophysical properties. The samples and the reference material tube are preheated in a water bath above the melting temperature of the PCM. It is subsequently subjected to a sudden change in temperature, exposed to room temperature. Its temperature history curves are recorded as it cools. Thermal properties monitor on cooling. During this process, the PCM is subject to natural convection heat transfer with the surrounding air.

The rate at which heat transfer occurs by natural convection is a function of the area over which the heat transfer operates and the difference in temperature. This method is adopted considering that the distribution temperature throughout the sample is uniform, assuming that the temperature does not vary with position but with time. Uniformity is achieved by satisfying the condition of the Biot number (Bi) less than 0.1 (Bi represents the ratio of heat transfer by convection to conduction).

PCMs are used in two main applications, thermal management and thermal energy storage. The interest of PCMs for thermal management dates back to the 1970s when NASA was interested in the use of PCMs as thermal condensers, in various space vehicles. In that decade, interest was also generated in solar systems, both in solar plants and in domestic applications. Its possible application has recently been seen in textile materials for military and consumer products. They have a large energy storage capacity, so they can have a more efficient thermal management. They act as thermoregulators by decreasing the thermal oscillation around the PCM phase change temperature. The specific applications in which PCMs have been used: Thermal storage of solar energy; Passive storage in buildings; For cooling (ice bank); Obtaining sanitary hot water; Maintaining constant temperatures in rooms with computers and electrical devices; Thermal protection of food during transportation; Thermal protection of agricultural products (wine, milk, vegetables); Thermal protection of electronic devices, avoiding overheating; Reduction of thermal fatigue in devices; Medical applications: thermal protection for the transport of blood, maintenance of the temperature of the operating table, hot-cold therapies; Machine coolant; Obtaining thermal comfort in vehicles; Damping of exothermic zenith temperatures in chemical reactions; Solar power plants; and aerospace systems.

The Brunauer, Emmettt and Teller (BET) model of gas adsorption on a solid surface (BET) has been shown to successfully predict phase diagrams and eutectic mixtures of hydrated and highly soluble salts. Actually, this model is a modification for hydrated salts because the hydration phenomenon of a salt is similar to the adsorption of gas on a solid surface. Ally and Braunstein (Ally M R, Braunstein J. BET model for calculating activities of salt and water, molar enthalpies, molar volumes and liquid-solid phase behavior in concentrated electrolyte solutions. Fluid Phase Equilibria 1993; 87: 213-236. Https://doi.org/10.1016/0378-3812(93)85028-K) shows the calculation of salt and water activities in multicomponent systems. For the prediction of these thermodynamic properties, the modified BET model has the advantage over other models (for example, Pitzer, UNIQUAC, NRTL, etc.) of having a smaller number of parameters to represent thermodynamic properties with reasonable precision in intervals: of temperatures and broad concentrations (Voigt W. Calculation of salt activities in molten salt hydrates applying the modified BET equation, I: binary system. Monatsh Chem 1993; 124: 839 48. https://doi.org/10.1007/BF00816406; Zeng D, Voigt W. Phase diagram calculation of molten salt hydrates using the modified BET equation. Calphad 2003; 27 (3): 243-251. Https J/doi.org/10.1016/j.calphad.2003.09.004).

Zeng and Voigt (Zeng D, Voigt W. Phase diagram calculation of molten salt hydrates using the modified BET equation. Calphad 2003; 27 (3): 243-251. Https://doi.org/10.1016/j.calphad.2003.09.0.004) used the modified BET model for the prediction of phase diagrams of ten ternary systems formed by two salts and water, the salts studied were LiNO₃, NaNO₃, Mg(NO₃)₂, Ca(NO₃)₂, Zn(NO₃)₂, LiCl, CaCl₂), LiClO₄ and Ca(ClO₄)₂, where 57 eutectic and peritectic points were found between the temperature ranges of 14° C. and 115° C. For example, among the expected systems the eutectic mixture was found at a temperature of 19° C. with a composition of 22.6% by weight of LiNO₃ and 41.4% by weight of Ca(NO₃)₂, the rest is water. Another example is the eutectic at 14.3° C. of solid phases LiNO₃—LiCl₂H₂O—LiCl. H₂O with a composition of 38.9% by weight of LiNO₃ and 10.8% by weight of LiCl.

Li et al (U B, Zeng D, Yin X, Chen Q. Theoretical prediction and experimental determination of room-temperature phase change materials using hydrated salts as agents. J Therm Anal Calorim 2010; 100(2):685-93. https://link.springer.com/article/10.1007%2Fs10973-009-0206-1) applied the modified BET model for the prediction of the phase diagrams of four ternary systems NH₄NO₃—LiNO₃—H₂O, LiNO₃—NaNO₃—H₂O, NaNO₃—Mg(NO₃)₂—H₂O and LiNO₃—Mg(NO₃)₂—H₂O and a quaternary system LiNO₃—NaNO₃—Mg(NO₃)₂—H₂O, finding two eutectic points with melting temperature close to room temperature. The compositions found of the ternary system were 66.17% by weight of LiNO₃.3H₂O and 33.83% by weight of NH₄NO₃ with melting points of 15° C. and 181 J/g of latent heat. The composition of the quaternary system found was 67.4% by weight of LiNO₃. 3H₂O, 26.9% by weight of Mg(NO₃)₂. 6H₂O and 5.7% by weight of NaNO₃, with a melting point of 15.5° C. and 181 J/g. Both expected PCMs possess excellent thermal stability. Xia et al. (Xia Y. Phase Diagram Prediction of the Quaternary System LiNO₃—Mg(NO₃)₂—NH₄NO₃—H₂O and Research of Related Phase Change Material. Chinese J Inorg Chem 2012; 28 (9): 1873-1877) also applied the BET model modified for the prediction of the phase diagrams of the LiNO₃—Mg(NO₃)₂—NH₄NO₃—H₂O system, they found a lower temperature eutectic point of 13.3° C., with a composition by weight of 25.5% NH₄NO₃, 28.4% LiNO₃, 13.8% Mg(NO₃)₂ and 32.3% H₂O and melting heat 192.7 J/g.

Air Conditioning (AC) systems assisted by Solar Energy are known that have flat plate solar collectors. The medium of the solar collector is water without additives (Rosiek S, Battles Garrido F J. Performance evaluation of solar-assisted air-conditioning system with chilled water storage (CIESOL building). Energ Conyers Manage 2012; 55: 81-92. https://doi.org/10.1016/j.enconman.2011.10.025). The solar-assisted AC system uses the single-acting LiBr—H₂O absorption chiller driven by hot water. The single acting LiBr—H₂O absorption chiller consists of the generator, condenser, absorber, evaporator, heat exchanger and expansion valve. It also uses a cooling tower, two hot storage tanks, an auxiliary heater, two chilled water storage tanks, three water pumps, and ten three-way valves. Likewise, they can be added in the cooling tanks with water through SHTES.

Regarding patent literature it is possible to mention CN109923731A (LG CHEM) which refers to a battery cooling heatsink applied with PCM capsule and a battery module including the same, which employs a PCM to solve a problem of a battery cooling heat sink indicating that the temperature of a coolant flowing into a battery module is not constant and adjusts the coolant temperature evenly. The heatsink can minimize the temperature difference of the coolant formed in the battery module, and prevent the temperature of an outlet side from which the coolant is discharged from rising.

US20190137190A1 (University of Texas) describes latent heat storage devices, such as latent heat storage devices that comprise a phase change material encapsulated in sufficiently conductive tubes, in which the tubes are arranged in a hexagonal packed pattern. The devices can be used, for example, in residential and/or commercial HVAC systems.

US20170002246A1 (Sigma Energy Storage INC.) Discloses heat transfer fluids comprising at least one organic fluid, such as an oil and at least one phase change material such as a molten salt that exhibits advantageous heat storage capabilities and properties. viscosity for heat transfer in systems such as compressed air energy storage systems.

CN105492566A (University of Texas) discloses mixtures of galactitol and mannitol sugar alcohol and compositions comprising such mixtures are described as phase change materials (PCM). A method for forming carbon nanotubes on a carbon substrate is described. Carbon substrates with carbon nanotubes are also described, in particular, conformal layers of carbon nanotubes on carbon substrates, as well as the methods of manufacture and use of these materials. Thermal storage units are also provided. Thermal storage units may comprise a heat exchange path through which a heat exchange medium flows, and a thermal storage medium in thermal contact with the heat exchange path.

US20130240188A1 (Tahoe Technologies, Ltd.) provides devices and methods for an improved dry cooling condensing system. In certain embodiments, the methods involve receiving steam from a steam source (eg, a power plant); condensing the steam into water while transferring the latent heat of the steam to the latent heat of a thermal storage material; and dissipate the latent heat from the thermal storage material at a later time when the ambient temperature is lower than the ambient temperature at the time the vapor condensed into water.

GB8321174D0 (Pennwalt Corp) discloses a thermal energy storage capsule comprising a thermal energy storage material capable of undergoing a reversible phase change from solid to liquid, encapsulated in a multilayer capsule having a maximum external dimension in the range of 3.2 at 25.4 mm and defines a cavity that contains the phase change material, the quantity of which is such that the volume of the phase change material, that is, liquid or solid, is equal to or less than the volume of the cavity. Capsules are used as thermal energy storage elements in structural elements of concrete or plaster construction. Capsules are manufactured by forming compacted or agglomerated cores of phase change material having a bulk density less than that of the corresponding molten liquid, molding the capsule around the core, melting the core and allowing the melt to resolve within the capsule. Preferred thermal storage materials and capsule wall materials are described.

Ushak, S., Vega, M., Lovera-Copa, J. A., Pablo, S., Lujan, M., & Grageda, M. (2020). Thermodynamic modeling and experimental verification of new eutectic salt mixtures as thermal energy storage materials. Solar Energy Materials and Solar Cells, 209, 110475, apply the modified BET model to obtain phase diagrams and design new eutectic mixtures. As a result, the eutectic composition and the melting point of two mixtures based on salt hydrates: LiNO₃.3H₂O—NaNO₃—Mn(NO₃)₂.6H₂O and LiNO₃.3H₂O—Mn(NO₃)₂.6H₂O—Mg(NO₃)₂.6H₂O. Both mixtures have the same predicted melting temperature of 10.8° C. The experimental verifications by the T history method showed a satisfactory conformity of the predicted temperature values with a difference of 0° and +2.3° C. for the mixtures, with sodium nitrate and magnesium nitrate, respectively. It was added that thermal and physical properties such as density, heat capacity for solid and liquid phases, as well as viscosity and volume change during melting of the new PCMs were evaluated. Characterization results, energy storage density (approximately 300 MJm⁻³), and material cost estimate show that both mixtures are promising candidates for use in low-temperature energy storage systems.

Lovera, JA, Ushak, S., Flores, EK, Fernandez, AG, & Galleguillos, H. (2020) refers to a chemical equilibrium model to represent solubilities of ternary systems and its application to the prediction of eutectics of quaternary systems. I will engineer. Chilean Engineering Magazine, 28 (1), 31-40, indicates that incorporating solar energy in the housing sector requires adequate materials for energy storage. Some eutectic mixtures of hydrated inorganic salts are a good alternative. Experimental methods are usually used to find a eutectic mixture with a melting temperature dose to that of the environment. An alternative method, which does not require much time and money, is to predict the eutectic point using a suitable thermodynamic model. In the present study, a rigorous parameterization of the Brunauer, Emmett and Teller model (BET model) has been carried out to successfully represent the solid-liquid equilibrium (solubilities) at 0 and 20° C. of the ternary systems NaNO₃+Ca (NO₃)₂+H₂O and NH₄NO₃+Ca(NO₃)₂+H₂O. The chemical equilibrium model obtained has been extended to predict the eutectic points of two quaternary systems: LiNO₃+NaNO₃+Ca(NO₃)₂+H₂O and LiNO₃+NH₄NO₃+Ca(NO₃)₂+H₂O. The expected melting temperatures are 15.9° C. and 3.9° C., respectively. Based on these results, it can be concluded that the first quaternary system has a greater potential to be used as a material for energy storage in buildings and homes.

Journal of Thermal Analysis and Calorimetry. Lovera-Copa, J. A., Ushak, S., Reinaga, N. et al. Design of phase change materials based on salt hydrates for thermal energy storage in a range of 4-40° C. J Therm Anal Calorim 139, 3701-3710 (2020). https://doi.org/10.1007/s10973-019-08655-1, predicts melting temperatures and compositions of eutectic mixtures of LiNO₃—LiClO₄—H₂O, NaNO₃—Ca(NO₃)₂—H₂O and NH₄NO₃— systems Mn(NO₃)₂—Mg(NO₃)₂H₂O using the Brunauer, Emmett and Teller modified (BET) thermodynamic model. For the ternary system with calcium nitrate and for the quaternary system, it was necessary to estimate the mixing parameters Xij with solid-liquid equilibrium data, which quantify the interaction between the compounds NaNO₃—Ca(NO₃)₂ and NH₄NO₃—Mn(NO₃)₂, respectively. The results calculated with the modified BET thermodynamic model show melting temperatures of 28.3° C. and 27.0° C. for the lithium perchlorate system, 33.2° C. for the calcium nitrate system and 4.0° C. for the quaternary system. The calculated values were tested experimentally with the T history method for the LiNO₃—LiClO₄—H₂O and NH₄NO₃—Mn(NO₃)₂—Mg(NO₃)₂—H₂O systems and with the DSC method for NaNO₃—Ca(NO₃)₂—H₂O system. The experimental results of the expected eutectic mixtures show good thermal behavior and can be useful as phase change materials (PCM) for their application in the design and simulation of refrigeration and air conditioning systems in residential and commercial buildings.

Article in Renewable and Sustainable Energy Reviews. Wong-Pinto, L. S., Milian, Y., & Ushak, S. (2020). Progress on use of nanoparticles in salt hydrates as phase change materials. Renewable and Sustainable Energy Reviews, 122, 109727, discloses that salt hydrates are considered promising materials for thermal energy storage (TES) and are widely used in different areas, however, these compounds have several drawbacks that are currently intended to to get better. In this regard, the use of nanoparticles has recently been proposed to treat the low thermal conductivity and the high degree of subcooling of salt hydrates. Consequently, the objective of this review was to analyze and compare the improvement of the properties of salt hydrates and their eutectic mixtures by nanoparticles. The methods of adding nanoparticles to salt hydrates were also classified and discussed, in addition, the influence of nanoparticles on thermal and physical properties, such as viscosity and latent heat, was discussed. Thermal conductivity and subcooling are among the properties that show great benefit from nanoparticles, therefore, PCM enhancement with nanomaterials can promote their application in buildings, heat exchangers, solar power plants and solar cookers, among others. These improvements achieved for the salt hydrates project them as excellent PCM, making them suitable for the market.

Su, W., Darkwa, J., & Kokogiannakis, G. (2015). Review of solid-liquid phase change materials and their encapsulation technologies. Renewable and Sustainable Energy Reviews, 48, 373-391 is a review of various types of solid-liquid phase change materials (PCM) for thermal energy storage applications. The review has shown that solid-liquid organic PCMs have many more advantages and capabilities than inorganic PCMs, but they have low thermal conductivity and density, as well as being flammable. Inorganic PCMs have higher heat storage capacities and conductivities, cheaper and more readily available, as well as being non-flammable, but they experience supercooling and phase segregation problems during the phase change process. The review has also shown that eutectic PCMs have a unique advantage as their melting points can be adjusted. Furthermore, they have relatively high conductivity and thermal density, but possess low latent and specific heat capacities. In general, the in situ polymerization method appears to offer the best technological approach in terms of encapsulation efficiency and structural integrity of the core material. However, there is a need to develop methods of improvement and standardization of test procedures for microencapsulated PCM.

Schmit, H., Rathgeber, C., Hennemann, P., & Hiebler, S. (2014). Three-step method to determine the eutectic composition of binary and ternary mixtures. Journal of Thermal Analysis and Calorimetry, 117 (2), 595-602, introduces a three-step method for determining the eutectic composition of a binary or ternary mixture. The method consists of creating a temperature-composition diagram, validating the predicted eutectic composition using differential scanning calorimetry and subsequent T-History measurements. To test the three-step method, two new eutectic phase change materials were used based on Zn(NO₃)₂.6H₂O and NH₄NO₃ respectively Mn(NO₃)₂.6H₂O and NH₄NO₃ with liquid equilibrium temperatures of 12.4° C. and 3.9° C. respectively. Eutectic compositions of 75/25% by mass are presented for Zn(NO₃)₂.6H₂O and NH₄NO₃ and 73/27% by mass for Mn(NO₃)₂.6H₂O and NH₄NO₃.

Article in Journal of Thermal Analysis and Calorimetry May 2010. DOI:10.1007/s10973-009-0206-1. B. Li, D. Zeng, X. Yin, Q. Chen, Theoretical prediction and experimental determination of room-temperature phase change materials using hydrated salts as agents, J. Therm. Anal. Calorim. 100 (2010) 685-693, applies a BET thermodynamic model and its recently modified version to predict the phase diagrams of the NH₄NO₃—LiNO₃—H₂O and NaNO₃—LiNO₃—Mg (NO₃)₂—H₂O systems, in which they were found two eutectic points with melting point at temperatures between 15° C. and 25° C. Simple experiments were designed to measure the exothermic and endothermic behavior of the expected phase change materials. The experimental results showed that the theoretically expected materials have excellent exothermic and endothermic behavior at room temperature. In addition, the heats of fusion and solidification of the expected phase change materials were measured.

Kenisarin, M. M. (1993). Short-term storage of solar energy. 1. Low temperature phase-change materials. Geliotekhnika, 29 (2), 46-64 considers a wide range of compounds based on salt hydrates to store heat and cold, as well as materials with phase transition in solid state. Methods are described to prevent supercooling of salt hydrates. The factors that favor increasing the stability of hydrates and maintaining their high heat storage capacity are analyzed. The properties of the compositions based on Glauber's salt, calcium chloride exahydrate and sodium acetate trihydrate, which are the most promising for the storage of solar energy, are considered in detail. Data on chemical compatibility of some engineering and heat storage materials are presented. List of commercially produced heat storage products is provided.

Abhat, A. (1983). Low temperature latent heat thermal energy storage: heat storage materials. Solar energy, 30 (4), 313-332 reviews heat-of-fusion storage materials for low-temperature latent heat storage in the 0-120° C. temperature range. Organic and inorganic heat storage materials classified as paraffins, fatty acids, inorganic salt hydrates, and eutectic compounds are considered. The melting and freezing behavior of the various substances is investigated using the techniques of thermal analysis and differential scanning calorimetry. The importance of thermal cycling tests to establish the long-term stability of storage materials is discussed. Finally, some data related to the corrosion compatibility of heat of fusion substances with conventional construction materials are presented.

The present invention proposes phase change materials (PMC) for applications in refrigeration systems specifically in the range 0 to 15° C. that considers AC systems assisted with solar energy contain cold water storage tanks and require storage systems. efficient in these temperature ranges. These PMCs correspond to quaternary eutectic mixtures based on inorganic salts, which were characterized by their physical and thermal properties for potential use in the AC system assisted by solar energy. The present invention provides quaternary mixtures obtained from the modified BET model, with their respective melting temperatures, composition and phase diagrams to be used in 2 tanks, of 5000 L each, which, when tested in an AC system such as the one described above, demonstrated function properly. These mixtures were compared with other quaternary mixtures also obtained from the modified BET model, and demonstrated in addition to working to do so advantageously. The expected quaternary mixtures are: LiNO₃—NaNO₃—Mn(NO₃)₂—H₂O, LiNO₃—NH₄NO₃—Mn(NO₃)₂—H₂O, LiNO₃—Mn (NO₃)₂—Mg (NO₃)₂—H₂O, LiCl—LiNO₃—LiClO₄—H₂O, LiNO₃—NH₄NO₃—Ca(NO₃)₂—H₂O, LiNO₃—NaNO₃—Ca(NO₃)₂—H₂O, NH₄NO₃—Mn(NO₃)₂—Mg(NO₃)₂—H₂O, NaNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O. The mixtures proposed as advantageous are: LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn (NO₃)₂—Ca(NO₃)₂—H₂O, with melting temperatures of 10.8, −1.1, 13.1, 12.0 and 7.1° C., respectively.

### BRIEF DESCRIPTION OF FIGURES

FIG. 1 Schematic of the experimental cooling and heating equipment to measure the temperature of the PCM. (1) Heat controller, (2) Water bath, (3) PCM sample tube, (4) Beaker, (5) Temperature sensor, and (6) Temperature data logger.

FIG. 2 Calculated phase diagram of the quaternary system LiNO₃—NaNO₃—Mn(NO₃)₂—H₂O. ( . . . ), Isotherms; (-), univariate line; (∘), and expected eutectic Point; [symbol] , A, B y C composition to compare. Upper vertex: Mn(NO₃)₂.6H₂O. Right lower vertex: NaNO₃ and Left lower vertex: LiNO₃.3H₂O.

FIG. 3 Calculated phase diagram of the quaternary system LiNO₃—NH₄NO₃—Mn(NO₃)₂—H₂O ( . . . ), Isotherms; (-), univariant line; (∘), and expected eutectic Point.

FIG. 4 Calculated phase diagram of the quaternary system LiNO₃—Mn(NO₃)₂—Mg(NO₃)₂—H₂O ( . . . ), Isotherms; (-), Univariant line; (∘), and expected eutectic Point; [symbol] , A, B and C composition to compare.

FIG. 5 Calculated phase diagram of the quaternary system LiCl—LiNO₃—LiClO₄—H₂O ( . . . ), Isotherms; (-), univariant line; (∘), and expected eutectic Point.

FIG. 6 Calculated phase diagram of the quaternary system NaNO₃—NH₄NO₃—Ca(NO₃)₂—H₂O ( . . . ), Isotherms; (-), univariant line; (∘), and expected eutectic Point.

FIG. 7 Calculated phase diagram of the quaternary system LiNO₃—NaNO₃—Ca(NO₃)₂—H₂O ( . . . ), Isotherms; (-), univariant line; (∘), and expected eutectic Point.

FIG. 8 Calculated phase diagram of the quaternary system NH₄NO₃—Mn(NO₃)₂—Mg(NO₃)₂—H₂O ( . . . ), Isotherms; (-), univariant line; (∘), and expected eutectic Point.

FIG. 9 Calculated phase diagram of the quaternary system NaNO₃—Mn(NO₃)₂—Mg(NO₃)₂—H₂O ( . . . ), Isotherms; (-), univariant line; (∘), and expected eutectic Point.

FIG. 10 Calculated phase diagram of the quaternary system LiNO₃—NH₄NO₃—Mg(NO₃)₂—H₂O ( . . . ), Isotherms; (-), univariant line; (∘), and expected eutectic Point.

FIG. 11 Calculated phase diagram of the quaternary system LiNO₃—Mn(NO₃)₂—Ca(NO₃)₂—H₂O ( . . . ), Isotherms; (-), univariant line; (∘), and expected eutectic Point.

FIG. 12 Temperature as function of time in the quaternary system LiNO₃—NaNO₃—Mn(NO₃)₂—H₂O. (-), PCM; (---), cooling liquid.

FIG. 13 Temperature as function of time in the quaternary system LiNO₃—NH₄NO₃—Mn(NO₃)₂—H₂O. (-), PCM; (---), cooling liquid.

FIG. 14 Temperature as function of time in the quaternary system LiNO₃—Mn(NO₃)₂—Mg(NO₃)₂—H₂O.(-), PCM; (---), cooling liquid.

FIG. 15 Temperature as function of time in the quaternary system LiCl—LiNO₃—LiClO₄—H₂O. (-), PCM; (---), cooling liquid.

FIG. 16 Temperature as function of time in the quaternary system LiNO₃—NH₄NO₃—Ca(NO₃)₂—H₂O. (-). PCM; (---), cooling liquid.

FIG. 17 Temperature as function of time in the quaternary system LiNO₃—NaNO₃—Ca(NO₃)₂—H₂O. (-), PCM; (---), cooling liquid.

FIG. 18 Temperature as function of time in the quaternary system NH₄NO₃—Mn(NO₃)₂—Mg(NO₃)₂—H₂O. (-), PCM; (---), cooling liquid.

FIG. 19 Temperature as function of time in the quaternary system NaNO₃—Mn(NO₃)₂—Mg(NO₃)₂—H₂O. (-), PCM; (---), cooling liquid.

FIG. 20 Temperature as function of time in the quaternary system LiNO₃—NH₄NO₃—Mg(NO₃)₂—H₂O. (-), PCM; (---), cooling liquid.

FIG. 21 Temperature as function of time in the quaternary system LiNO₃—Mn(NO₃)₂—Ca(NO₃)₂—H₂O. (-), PCM; (---), cooling liquid.

FIG. 22 Temperature as function of time in the quaternary system LiNO₃—NaNO₃—Mn(NO₃)₂—H₂O. (-), PCMs (e, A, B y C); (---), cooling liquid.

FIG. 23 Temperature as function of time in the quaternary system LiNO₃—Mn(NO₃)₂—Mg(NO₃)₂—H₂O. (-), PCMs (e, A, B y C); (---), cooling liquid.

FIG. 24 Crystallization and melting heats of mixtures (black line) LiNO₃—NaNO₃—Mn(NO₃)₂—H₂O, (yellow line) LiNO₃—NH₄NO₃—Mn(NO₃)₂—H₂O, (purple line) LiNO₃—Mn(NO₃)₂—Mg(NO₃)₂—H₂O, (green line) LiNO₃—NH₄NO₃—Mg(NO₃)₂—H₂O and (blue line) LiNO₃—Mn(NO₃)₂—Ca(NO₃)₂—H₂O of eutectic composition measured by SC.

FIG. 25 (black line) LiNO₃—NaNO₃—Mn(NO₃)₂—H₂O, (yellow line) LiNO₃—NH₄NO₃—Mn(NO₃)₂—H₂O, (purple line) LiNO₃—Mn(NO₃)₂—Mg(NO₃)₂—H₂O, (green line) LiNO₃—NH₄NO₃—Mg(NO₃)₂—H₂O and (blue line) LiNO₃—Mn(NO₃)₂—Ca(NO₃)₂—H₂O.

### DETAILED DESCRIPTION OF THE INVENTION

It is an objective of the present invention to provide alternative phase change materials (PCM) can be integrated to short-term thermal storage units (STES), as part of a solar refrigeration/heater system (SCH) to improve energetic efficiency in the building area.

In this way, the need to use heat or cold in the absence of the source that generates this heat or cold is solved, through its storage and subsequent release, in materials designed for this purpose. Phase Change Materials (PCM) operate at a fixed temperature corresponding to their melting temperature. PCMs change from a solid to a liquid state or vice versa and in this transition they can absorb or release a large amount of thermal energy, accumulating energy in the form of latent heat of fusion. The final application of these PCMs is defined by their melting temperature. PCMs are applied in passive air conditioning of buildings, heating/cooling systems, in electronic devices, optimization of hot/cold water tanks and even in solar plants. They cover a wide range of temperatures: from −40° C. to 500° C.

Then, alternative phase change materials (PCM) to the known ones were developed, using mixtures of inorganic nitrate salts as a base, which can be integrated into short-term thermal energy storage units (STES), as part of a solar cooling/heating system (SCH), to improve energy efficiency in the construction sector, in food transport, and in general, in any industrial/residential application that requires heat or cold to the phase transition temperature of PCMs. The eutectic mixtures developed have been tested at the laboratory level with no scaling data to any other semi-industrial level.

PCMs are used on a real scale in the air conditioning of buildings, both as a passive system with the integration of these in the envelopes (application range T=18-24° C.), as an active system, for example, in water storage ponds cold or hot (T=7-12° C. or 40 60° C.). Also, they are used in the transport sector with the need for cold, to transfer perishable substances/objects (food, vaccines). There are references to its patenting and use in solar systems.

The eutectic mixtures of table 5 and their use as PMC in AC systems is an objective of the present invention.

TABLE 5

| | | T melt | | | | |
|---|---|---|---|---|---|---|
| | Components of inorganic | “onset” | ΔH | Cp solid, | | Cp liq |
| No | salts mixtures + H₂O | (° C.) | kJ · kg−1 | J · g−1 · K−1 | | J · g−1 · K−1 |
| PCM 1 | LiNO₃—NaNO₃—Mn(NO₃)₂ | 11 | 158 | 1.538 | (0° C.) | 2.500 (17° C.) |
| PCM 2 | LiNO₃—NH₄NO₃—Mn(NO₃)₂ | −2 | 136 | 2.000 | (−26° C.) | 2.892 (12° C.) |
| PCM 3 | LiNO₃—Mn(NO₃)₂—Mg(NO₃)₂ | 13 | 133 | 1.227 | (0° C.) | 2.600 (30° C.) |
| PCM 4 | NaNO₃—Mn(NO₃)₂—Mg(NO₃)₂ | 22 | not measured | not measured | | not measured |
| PCM 5 | LiNO₃—NH₄NO₃—Mg(NO₃)₂ | 12 | 163 | 1.790 | (−23° C.) | 2.961 (25° C.) |
| PCM 6 | LiNO₃—Mn(NO₃)₂—Ca(NO₃)₂ | 7 | 108 | 2.304 | (−26° C.) | 2.536 (12° C.) |

The modified BET model for calculating the activity of salts and water in a multicomponent system was formulated from statistical mechanics by Ally and Braunstein (Ally M R, Braunstein J. Statistical mechanics of multilayer adsorption: electrolyte and water activities in concentrated solutions. J Chem Thermodyn 1998; 30(1):49-58. https://doi.org/10.1006/icht.1997.0278) Recently, a new version of this model has been published, where the system is considered as a regular solution and an empirical mixture parameter denoted by Ωij which represents the extra salt interactions i-sal j. Considering this modification, mathematical expressions of the activities of the system components were developed. The model parameters are given for various inorganic salts in the literature usually as a linear correlation with temperature, this is because the parameters do not vary strongly with temperature. Table 6 shows the data collected from the literature the parameters rᵢ and ΔEᵢ for the salts that form the quaternary systems and with which the calculations were carried out in the mathematical equations proposed by the literature to propose 10 quaternary mixtures. Table 7 shows the interaction parameters of Ωij as used.

Table 6 shows the data collected from the literature the parameters rᵢ and ΔEᵢ

| | r = a + bT | | ΔE = c + dT/(J · mol⁻¹) | | | |
|---|---|---|---|---|---|---|
| Salt | a | B | C | D | Range | Source |
| LiCl | 4.732 | −0.00378 | −8166.6 | 3.526 | 273-373 | Zeng D, Ming J, Voigt W. Thermodynamic study of the system |
| | | | | | | (LiCl + LiNO₃ + H₂O). J Chem. Thermodyn. 2008; 40(2): 232- |
| | | | | | | 239. https://doi.org/10.1016/j.jct.2007.06.018 |
| LiClO₄ | 3.167 | 0 | −7501 | 0 | 298 | (Zeng D, Voigt W. Phase diagram calculation of molten salt |
| | | | | | | hydrates using the modified BET equation. Calphad |
| | | | | | | 2003; 27(3): 243-251. |
| | | | | | | https://doi.org/10.1016/j.calphad.2003.09.004; Zeng D, Ming |
| | | | | | | J, Voigt W. Thermodynamic study of the system |
| | | | | | | (LiCl + LiNO₃ + H₂O). J Chem Thermodyn 2008; 40(2): 232-239. |
| | | | | | | https://doi.org/10.1016/j.jct.2007.06.018) |
| LiNO₃ | 2.766 | 0.000143 | −6583.6 | 5.495 | 293-373 | (Zeng D, Ming J, Voigt W. Thermodynamic study of the system |
| | | | | | | (LiCl + LiNO₃ + H₂O). J Chem Thermodyn 2008; 40(2): 232-239. |
| | | | | | | https://doi.org/10.1016/j.jct.2007.06.018) |
| NaNO₃ | 1.8 | 0 | −1000 | 0 | 373 | (Zeng D, Ming J, Voigt W. Thermodynamic study of the system |
| | | | | | | (LiCl + LiNO3 + H2O). J Chem Thermodyn 2008; 40(2): 232-239. |
| | | | | | | https://doi.org/10.1016/j.jct.2007.06.018) |
| NH₄NO₃ | 1.63 | 0 | 890 | 0 | — | (Zeng D, Ming J, Voigt W. Thermodynamic study of the system |
| | | | | | | (LiCl + LiNO₃ + H₂O). J Chem Thermodyn 2008; 40(2): 232-239. |
| | | | | | | https://doi.org/10.1016/j.jct.2007.06.018/ |
| | | | | | | 01496390600743045 |
| Mg(NO₃)₂ | 5.579 | 0 | 0 | −31.348 | 303-358 | (Zeng D, Ming J, Voigt W. Thermodynamic study of the system |
| | | | | | | (LiCl + LiNO₃ + H₂O). J Chem Thermodyn 2008; 40(2): 232-239. |
| | | | | | | https://doi.org/10.1016/j.jct.2007.06.018/ |
| | | | | | | 01496390600743045 |
| Ca(NO₃)₂ | 5.032 | −0.0042 | −4183 | −4.88 | 298-373 | Zeng D, Voigt W. Phase diagram calculation of molten salt |
| | | | | | | hydrates using the modified BET equation. Calphad |
| | | | | | | 2003; 27(3): 243-251. |
| | | | | | | https://doi.org/10.1016/j.calphad.2003.09.004. |
| Mn(NO₃)₂ | 5.0 | 0 | −7160 | 0 | 298 | Zeng DW, Fan SS, Chen SH. Phase diagram prediction of |
| | | | | | | system Mn(NO₃)₂ —M(NO₃)ₙ—H₂O (M = Ca, Mg and Li) with |
| | | | | | | modified BET model. Trans Nonferrous Met Soc China |
| | | | | | | 2004; 6:1192-1198 |

TABLE 7
the interaction parameters of Ωij.

| | Ωij = A + BT/(J · mol⁻¹) | | | |
|---|---|---|---|---|
| Salt i-Salt j | A | B | Range | Source |
| LiCl—LiNO₃ | 2231.5 | 10 | 273-323 | Zeng D, Ming J, Voigt W. Thermodynamic study |
| | | | | of the system (LiCl + LiNO₃ + H₂O). J Chem |
| | | | | Thermodyn 2008; 40(2): 232-239. |
| | | | | https://doi.org/10.1016/j.jct.2007.06.018 |
| LiNO₃—NH₄NO₃ | 2759.3 | −14.286 | 273-363 | Zeng D, Ming J, Voigt W. Thermodynamic study |
| | | | | of the system (LiCl + LiNO₃ + H₂O). J Chem |
| | | | | Thermodyn 2008; 40(2): 232-239. |
| | | | | https://doi.org/10.1016/j.jct.2007.06.018 |
| NH₄NO₃—Mn(NO₃)₂ | 54031 | −219.129 | 273-320 | Zeng D W, Fan S S, Chen S H. Phase diagram |
| | | | | prediction of system Mn(NO₃)₂—M(NO₃)ₙ—H₂O |
| | | | | (M = Ca, Mg and Li) with modified BET model. |
| | | | | Trans Nonferrous Met Soc China 2004; 6: 1192-1198 |

As is known, the modified BET model has been successfully applied to calculate the melting temperature and chemical composition of a eutectic mixture of hydrated salts. For this purpose, the equations of the fusion process are required, which are known from the literature. Analogously to the parameters of the modified BET model, in the literature the coefficients A, B and C are also reported for various anhydrous and hydrated salts. In Table 8 these coefficients are given for the solids that establish the quaternary systems defined above.

TABLE 8
Constant coefficients Ink of different solid phases

| | Ink = A + B/T + Cln(T) | | | | |
|---|---|---|---|---|---|
| Solid Phase | A | B | C | Range, T/K | Source |
| LiCl•2H₂O | −36125.99 | 50.5965 | 0 | 273-292 | Zeng D, Ming J, Voigt W. Thermodynamic |
| | | | | | study of the system (LiCl + LiNO₃ + H₂O). |
| | | | | | J Chem Thermodyn 2008; 40(2): 232-239. |
| | | | | | https://doi.org/10.1016/j.jct.2007.06.018 |
| LiClO₃•3H₂O | 8.537 | −6505.9 | 0 | 298-368 | Zeng D, Voigt W. Phase diagram calculation |
| | | | | | of molten salt hydrates using the modified |
| | | | | | BET equation. Calphad 2003; 27(3): 243-251. |
| | | | | | https://doi.org/10.1016/j.calphad.2003.09.004 |
| LiNO₃•3H₂O | 11057.869 | −1235.211 | 198.82931 | 273-301 | Li B, Zeng D, Yin X, Chen Q. Theoretical |
| | | | | | prediction and experimental determination |
| | | | | | of room-temperature phase change materials |
| | | | | | using hydrated salts as agents. J Therm |
| | | | | | Anal Calorim 2010; 100(2): 685-93. |
| | | | | | https://link.springer.com/article/10.1007%2Fs10973-009-0206-1 |
| NaNO₃ | −15699.33 | 26.92 | 0 | 273-292 | Li B, Zeng D, Yin X, Chen Q. Theoretical |
| | | | | | prediction and experimental determination |
| | | | | | of room-temperature phase change materials |
| | | | | | using hydrated salts as agents. J Therm |
| | | | | | Anal Calorim 2010; 100(2): 685-93. |
| | | | | | https://link.springer.com/article/10.1007%2Fs10973-009-0206-1 |
| NH₄NO₃ | −29822.983 | 436.06597 | −60.704671 | 278-368 | Li B, Zeng D, Yin X, Chen Q. Theoretical |
| | | | | | prediction and experimental determination |
| | | | | | of room-temperature phase change materials |
| | | | | | using hydrated salts as agents. J Therm |
| | | | | | Anal Calorim 2010; 100(2): 685-93. |
| | | | | | https://link.springer.com/article/10.1007%2Fs10973-009-0206-1] |
| Ca(NO₃)₂•4H₂O | 6.263 | −5328.9 | 0 | 283-316 | Zeng D, Voigt W. Phase diagram calculation |
| | | | | | of molten salt hydrates using the modified |
| | | | | | BET equation. Calphad 2003; 27(3): 243-251. |
| | | | | | https://doi.org/10.1016/j.calphad.2003.09.004 |
| Mg(NO₃)₂•6H₂O | — | — | — | 273-362 | Li B, Zeng D, Yin X, Chen Q. Theoretical |
| | | | | | prediction and experimental determination |
| | | | | | of room-temperature phase change materials |
| | | | | | using hydrated salts as agents. J Therm |
| | | | | | Anal Calorim 2010; 100(2): 685-93. |
| | | | | | https://link.springer.com/article/10.1007%2Fs10973-009-0206-1 |
| Mn(NO₃₎₂•6H₂O^{a} | 38.845 | −25924 | 2672400 | 278-300 | Rains W O, Courice R M. Liquidus Curves |
| | | | | | of NH₄NO₃(aq) Calculated from the Modified |
| | | | | | Adsorption Isotherm Model for Aqueous |
| | | | | | Electrolytes. Sep Sci Technol 2006; 41(11): |
| | | | | | 2629-2634. https//doi:10.1080/01496390600743045 |

^{a}Equation of the equilibrium constant is Ink = A + B/T + C/T².

Based on the values of the activities ai and aw of the modified BET model and the natural logarithm of the equilibrium constant Ink, the solubility and composition of the eutectic points of the systems are calculated by means of a calculation program. The results found can be better expressed in relative amounts as in the weight fraction scale. The calculation program also allowed the construction of the solid-liquid phase diagrams of the following 10 systems/mixtures: LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiCl—LiNO₃—LiClO₄—H₂O, LiNO₃—NH₄NO₃—Ca(NO₃)₂—H₂O, LiNO₃—NaNO₃—Ca(NO₃)₂—H₂O, NH₄NO₃—Mn(NO₃)₂—Mg(NO₃)₂—H₂O, NaNO₃—Mn(NO₃)₂—Mg(NO₃)₂—H₂O, LiNO₃—NH₄NO₃—Mg(NO₃)₂—H₂ and LiNO₃—Mn(NO₃)₂—Ca(NO₃)₂—H₂O.

The mixtures were prepared following the mass ratio (compositions) of Table 9, and the eutectic mixtures were tested as PCM when it was confirmed that the expected values coincided with the values obtained from the experimentation, in the mixture being tested, and finally characterized by the properties of eutectic mixtures. See Table 9.

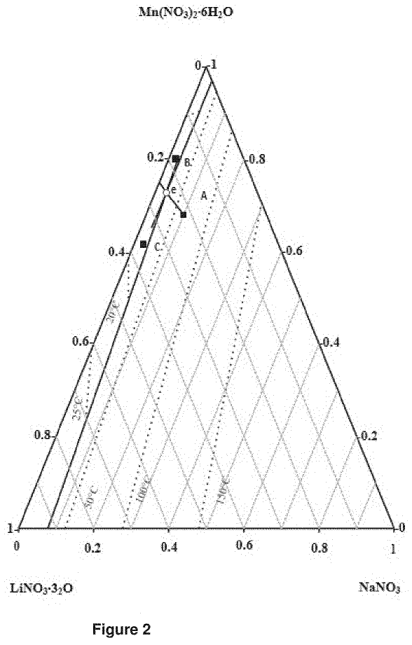

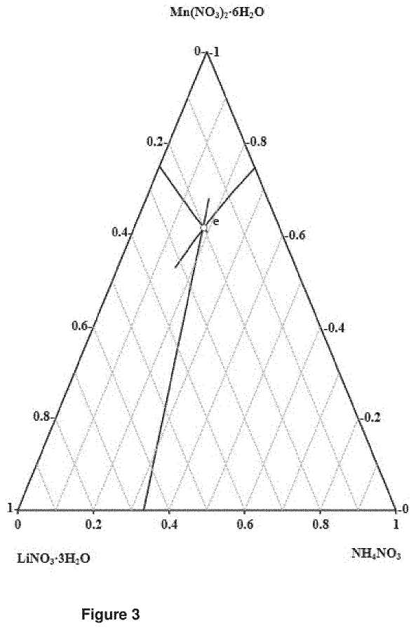

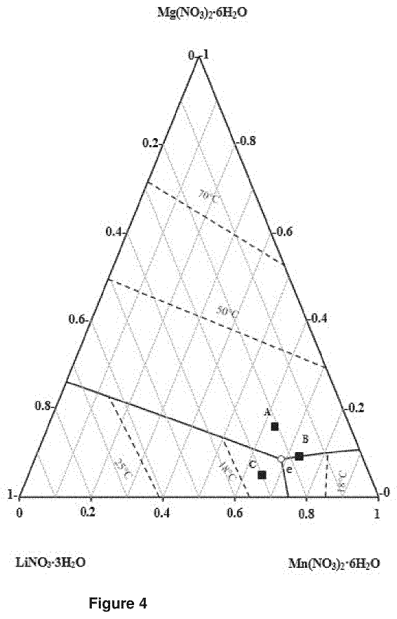

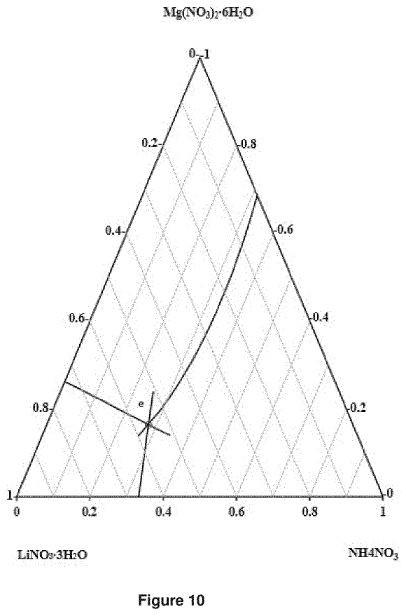

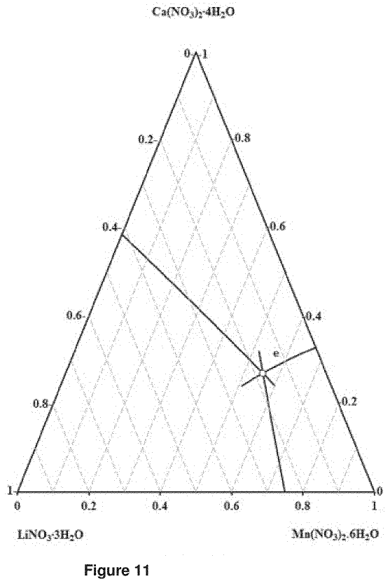

In addition to the mixtures with eutectic compositions and the eutectic point, the equations of the thermodynamic model were used for the construction of phase diagrams of quaternary systems of each mixture. The polythermic lines and the isotherms expected for each system/mixture, allowed to establish the eutectic composition as the point of intersection of the three polythermic lines (see FIGS. 2-11). Quaternary mixtures LiNO₃—NaNO₃—Mn(NO₃)₂—H₂O (see FIG. 2), LiNO₃—NH₄NO₃—Mn(NO₃)₂—H₂O (see FIG. 3), LiNO₃—Mn(NO₃)₂—Mg(NO₃)₂—H₂O (see FIG. 4), LiNO₃—NH₄NO₃—Mg(NO₃)₂—H₂O (see FIG. 10) and LiNO₃—Mn(NO₃)₂—Ca(NO₃)₂—H₂O (see FIG. 11) exhibited eutectic behavior.

Mixtures LiNO₃—NaNO₃—Mn(NO₃)₂—H₂O and LiNO₃—Mn(NO₃)₂—Mg(NO₃)₂—H₂O, They were tested in three compositions (A, B and C) that were close to the eutectic point (e) to compare the results with those of the eutectic quaternary mixture and use the information for the other mass relationships with the same components.

In summary, from the modified BET model, 10 mixtures of quaternary systems were defined that were LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiCl—LiNO₃—LiClO₄—H₂O, LiNO₃—NH₄NO₃—Ca(NO₃)₂—H₂O, LiNO₃—NaNO₃—Ca(NO₃)₂—H₂O, NH₄NO₃—Mn(NO₃)₂—Mg(NO₃)₂—H₂O, NaNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O for conditioning of environments in a range of 0 to 15° C. The expected phase change temperatures were 10.8° C., 3.4° C., 10.8° C., 8.9° C., 7.9° C., 16.4° C., 13° C., 20.6° C., 13.6° C. and 5.7° C., respectively. Phase diagrams were designed for the ten quaternary systems with the equations of the modified BET model.

Only 5 of the mixtures are eutectic, LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O. Two of the five eutectic samples were tested, LiNO₃—NaNO₃—Mn(NO₃)₂—H₂O and LiNO₃—Mn(NO₃)₂—Mg(NO₃)₂—H₂O. For the eutectic composition (e) found with a modified BET model, and for three points close to this (A, B and C) for two of the quaternary systems, LiNO₃—NaNO₃—Mn(NO₃)₂—H₂O and LiNO₃—Mn(NO₃)₂—Mg(NO₃)₂—H₂O, confirming the eutectic composition. From the T-history method it was determined that the behavior of both mixtures with composition e had the characteristic behavior of a compound with eutectic composition, unlike the mixtures, whose compositions were defined with the points A, B and C.

The subcooling present in the mixtures, by the T-history method, was 3.0, 2.7, 7.5, 3.4 and 2.9 LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively. Subcooling could be exceeded or decreased for a TES system application where large amounts of material are required. For applications where small amounts of PCM are required, it would be necessary to use nucleating agents.

The heat of fusion of the five mixtures was 172.5 kJ·kg⁻¹ to LiNO₃—NaNO₃—Mn(NO₃)₂—H₂O, 169.8 kJ·kg⁻¹ to LiNO₃—NH₄NO₃—Mn(NO₃)₂—H₂O, 152.8 kJ·kg⁻¹ to LiNO₃—Mn(NO₃)₂—Mg(NO₃)₂—H₂O, 187.6 kJ·kg⁻¹ to LiNO₃—NH₄NO₃—Mg(NO₃)₂—H₂O and 142.2 kJ·kg⁻¹ to LiNO₃—Mn(NO₃)₂—Ca(NO₃)₂—H₂O. The heat of crystallization of the mixtures was 157.7 kJ·kg⁻¹ to LiNO₃—NaNO₃—Mn(NO₃)₂—H₂O, 136.0 kJ·kg⁻¹ to LiNO₃—NH₄NO₃—Mn(NO₃)₂—H₂O, 133.4 kJ·kg⁻¹ to LiNO₃—Mn(NO₃)₂—Mg(NO₃)₂—H₂O, 162.6 kJ·kg⁻¹ to LiNO₃—NH₄NO₃—Mg(NO₃)₂—H₂O and 107.6 kJ·kg⁻¹ to LiNO₃—Mn(NO₃)₂—Ca(NO₃)₂—H₂O.

The solid state specific heat results for LiNO₃—NaNO₃—Mn(NO₃)₂—H₂O showed an increase with temperature ranging from 1.538 to 2.379 J·g⁻¹K⁻¹ in a range of temperature from 272.7 to 280.0 K, to LiNO₃—NH₄NO₃—Mn(NO₃)₂—H₂O the values vary from 2.001 to 2.166 J·g⁻¹·K⁻¹ in a range of temperature from 247.2 to 259.9 K, to LiNO₃—Mn(NO₃)₂—Mg(NO₃)₂—H₂O the values increase from 1.227 to 2.038 J·g⁻¹·K⁻¹ in a range of temperature from 269.9 to 280.1 K, to LiNO₃—NH₄NO₃—Mg(NO₃)₂—H₂O showing an increase that goes from 1.790 to 2.131 J·g⁻¹·K⁻¹ in a range of temperature from 250.5 to 265.1 K and to LiNO₃—Mn(NO₃)₂—Ca(NO₃)₂—H₂O the values vary from 2.304 to 1.946 J·g⁻¹·K⁻¹ in a range of temperature from 247.8 to 261.9 K. Further, specific heat experimental values of solid state were adjusted for the five eutectic mixtures.

Specific heat values were measured to liquid phase. To LiNO₃—NaNO₃—Mn(NO₃)₂—H₂O in a range of temperature from 290.0 to 302.1 K with values of 2.500 to 2.583 J·g⁻¹·K⁻¹, to LiNO₃—NH₄NO₃—Mn(NO₃)₂—H₂O in a range of temperature from 284.8 to 330.0 K with values of 2,892 to 3,174 J·g⁻¹·K⁻¹, to LiNO₃—Mn(NO₃)₂—Mg(NO₃)₂—H₂O in a range of temperature from 302.6 to 320.0 K with values of 2.600 to 2.446 J·g⁻¹·K⁻¹, to LiNO₃—NH₄NO₃—Mg(NO₃)₂—H₂O in a range of temperature from 297.4 to 330.0 K with values of 2.961 to 2.585 J·g⁻¹·K⁻¹ and to LiNO₃—Mn(NO₃)₂—Ca(NO₃)₂—H₂O in a range of temperature from 284.3 to 330.0 K with values from 2,536 to 2,441 J·g⁻¹·K⁻¹.

The dinamic viscosity of the studied mixtures was 18.18, 12.30, 18.15, 11.45 and 21.43 cP to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively.

The densisty of solid at 0° C. is 1.753, 1.679, 1.623 and 1.676 g·cm⁻³ to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O. respectively. While the density of solid to the mixture LiNO₃—NH₄NO₃—Mn(NO₃)₂—H₂O obtained at −5° C. was 1.641 g·cm⁻³.

The liquid density to eutectic mixtures was measured in a range of temperature between 25 and 45° C. and the values of density were found in the range from 1.65455 to 1.63891, 1.60102 to 1.57107, 1.63472 to 1.62144, 1.48125 to 1.46923 and 1.63005 to 1.61306 g·cm⁻³ to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively.

The volume change values were ΔV/N solid=4.9%, 4.2%, 2.1%, 2.0% and 0.4% to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively.

The energy storage density was 302.4, 278.6, 256.6, 304.5 and 238.3 MJ·m^{|3} to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively. The energy storage density to the five quaternary eutetic mixtures is found near to the values of commercial compounds, which ranging from 162.4 to 259.9 Mj·m⁻³ to ClimSel C10 and S10 (Commercial, PCM Products Ltd), respectively.

The results obtained from heat of fusion/crystallization, specific heat, density, and viscosity were shown to be adequate for the use of four mixtures as PCM in storage systems in the study range from 0 to 15° C. The mixture that must be discarded, for this application in this specific temperature range, is the mixture LiNO₃—NH₄NO₃—Mn(NO₃)₂—H₂O due to its melting temperature is −1.1° C.

The most suitable PCM to be used in the solar energy-assisted AC system is LiNO₃—NaNO₃—Mn(NO₃)₂—H₂O due to the results obtained in the characterizations, cost estimation and because its subcooling is lower than that of the other compounds studied at different volumes, as was the case with 15 mg in the DSC equipment (ΔT_{sub}=25.2° C.) and 12.5 g in the device to the T-history (ΔT_{sub}=3° C.).

All mixtures have potential for applications as thermal storage material, in systems, where the operating temperature range corresponds to the melting temperature of the PCM

### Examples

The reagents used in the preparation of the eutectic mixtures were: LiNO₃ purity+98.0% wt, NaNO₃ purity+99.7% wt, Mg(NO₃)₂0.6H₂O purity+99.5% wt, Mn(NO₃)₂.4H₂O purity+98.5% wt, NH₄NO₃ purity+95.0% wt, LiCl purity+99.0% wt, LiClO₄.3H₂O purity+98.0% wt, Ca(NO₃)₂.4H₂O purity+99.0% wt, ultra pure water.

The mixtures were prepared following the following protocol after washing and drying all the materials and utensils to be used (beakers, watch glasses, spatula), and letting them dry in an oven at 40° C., and performing the standard tasks associated with tare utensils for analytical balance measurements. A first salt is added to a beaker containing 100 mL of distilled water, and then a second salt different from the first, and then a third salt different from the first and second salts, the mixture is stirred at medium speed at a temperature of 30° C. for 1 hour and stir until all salts are dissolved. The amounts of the first, second and third salts and water are indicated in table 9.

TABLE 9

| System/Mixturea | T/(° C.) | Mass relation |
|---|---|---|
| LiNO₃•3H₂O:NaNO₃:Mn(NO₃)₂•6H₂O | 10.8 | 24.2:3.0:72.8 |
| LiNO₃•3H₂O:NH₄NO₃:Mn(NO₃)₂•6H₂O | 3.4 | 21.4:13.9:64.7 |
| LiNO₃•3H₂O:Mn(NO₃)₂•6H₂O:Mg(NO₃)₂•6H₂O | 10.8 | 22.9:68.6:8.5 |
| LiNO₃•3H₂O:LiCl:LiClO₄•3H₂O | 8.9 | 47.4:47.6:5.0 |
| LiNO₃•3H₂O:NH₄NO₃:Ca(NO₃)₂•4H₂O | 7.9 | 33.7:19.4:46.9 |
| LiNO₃•3H₂O:NaNO₃:Ca(NO₃)₂•4H₂O | 16.4 | 39.5:4.2:56.3 |
| NH₄NO₃:Mn(NO₃)₂•6H₂O:Mg(NO₃)₂•6H₂O | 13 | 12.7:74.3:13.1 |
| NaNO₃:Mn(NO₃)₂•6H₂O:Mg(NO₃)₂•6H₂O | 20.6 | 2.8:87.0:10.2 |
| LiNO₃•3H₂O:NH₄NO₃:Mg(NO₃)₂•6H₂O | 13.6 | 55.8:27.8:16.4 |
| LiNO₃•3H₂O:Mn(NO₃)₂•6H₂O:Ca(NO₃)₂•4H₂O | 5.7 | 17.7:55.3:27.0 |

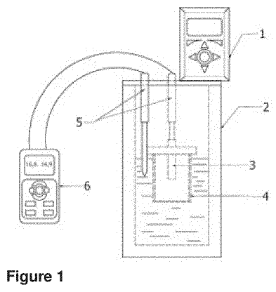

The crystallization and melting tests of the mixtures were carried out by the T-history method. They were carried out in a LAUDA ECO RE 420 thermostatted bath with a LAUDA Kryo 30 cooling liquid. The diagram of the experimental cooling and heating equipment is shown in FIG. 1. Inside the bath, a 100 mL glass bottle was fixed in the which was placed in a test tube containing 12.5 g of the eutectic mixture. Two precision ±0.5° C. type K thermocouples were used for the measurements, one was immersed in the center of the PCM and the other in the bath coolant. A PCE Instruments model PCE-T 390 data logger was used to store temperature versus time data, which were subsequently retrieved and analyzed on a computer.

For each of the samples found, a cooling/heating cycle was performed for the mixture. The thermostatted bath was programmed so that the temperature of the coolant decreases/increases in the range −30° C. and 30° C. at a rate of 6° C.·h⁻¹. Between the cooling and heating stages, one isotherm was programmed at −30° C. for 2 hours and the second isotherm at 30° C. for a period of 2 hours.

For two of the mixtures, which exhibited verified eutectic composition as described below, additional heating/cooling tests were performed to demonstrate eutectic behavior. For this, in the phase diagram of the corresponding mixture, three additional points were defined (called A, B and C) with a composition close to the eutectic (e) obtained by the modified BET model. The validation of the composition was carried out in a LAUDA ECO RE 420 thermostatized bath with a LAUDA Kryo 30 cooling liquid following the procedure set forth below.

Inside the thermostatized bath, a 200 mL glass bottle was fixed in which a long aluminum tube was placed, which contained 12.5 g of the eutectic composition mixture, as well as the mixture of the three different compositions to the point. Eutectic A, B, or C. Two ±0.5° C. precision K-type thermocouples were used for the measurements, one dipped into the center of the mix and the other into the bath coolant. Temperature data was recorded with PCE Instruments model PCE-T 390 and retrieved and analyzed by computer. A cooling/heating cycle was carried out for the mixture of composition A, B or C. The equipment was programmed so that the temperature of the cooling liquid decreases and increases in the range −20° C. and 28° C., at a speed of 6° C.·h⁻¹. Between the cooling and heating stages, one isotherm was programmed at −20° C. for 2 hours and the second isotherm at 28° C. for a period of 2 hours; fulfilling 20 hours of programming.

The presence of the shorter platform or the absence of it indicates the remoteness of the selected composition mixture from the eutectic composition mixture. This behavior would confirm if the composition of point (e) corresponds to a mixture of eutectic composition. The characterization of the thermal and physical properties was carried out for the mixtures of confirmed eutectic composition.

To determine the phase change temperatures, the latent heat of fusion and crystallization of the PCMs, a differential scanning calorimeter (DSC 204 F1 Phoenix NETZSCH with N2 atmosphere) was used. The tests were carried out under the protection of nitrogen at a constant gas volumetric flow of 20 mL·min⁻¹. The sample amount of the eutectic mixtures was approximately 15 mg. Two cooling/heating cycles were carried out in a temperature range that varies according to the melting and crystallization temperatures of each mixture, the ranges were −25-40° C., −50-20° C., −20-40° C., −40-60° C. and −50 20° C. to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively. The cooling/heating rate was carried out at 5 K·min⁻¹. The results of the second cycle were recorded. Aluminum crucibles with a 25 μL capacity were used. The phase change temperature and latent heat of the sample were obtained by analyzing the curves measured by the DSC.

Analysis of the specific heat of the eutectic mixtures was carried out using the DSC method, during the heating step. Temperature range −10-30° C., −30-60° C., −10-60° C., −30 60° C. and −30-60° C. to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively. The heating rate was 1 K·min⁻¹. Sapphire (monocrystalline alumina) was used as a reference material for specific heat measurements. In addition to measuring the Cp of eutectic mixtures, Cp adjustments were made for the solid and liquid phases and the best correlation was found.

The dynamic viscosity of all liquid mixtures was determined experimentally with a Schott-Gerate viscometer. The measurement is based on the time that the liquid elapses between two points in a Micro-Ostwald type capillary. The viscometer is automatic and requires 2 mL of liquid sample for its measurement.

The density of the solid phase quaternary eutectic mixtures was determined using a pycnometer with n-dodecane as displacement liquid. (Xia Y. Phase Diagram Prediction of the Quaternary System LiNO₃—Mg(NO₃)₂—NH₄NO₃—H₂O and Research of Related Phase Change Material. Chinese J Inorg Chem 2012; 28(9):1873-1877). On the other hand, the density of the liquid phase was measured by an oscillation densimeter (Mettler Toledo model DE50). Density measurements were performed in triplicate for the solid and liquid phases.

To measure the density of the pure PCM, a METTLER TOLEDO model DE 50 density meter was used, which can measure densities in a range of 0 to 3 g·cm⁻³. The resolution of this equipment is 1×10⁻⁵ g·cm⁻³. The temperature range of the equipment is 4° C. to 70° C. Density measurements were carried out in triplicate for the following temperatures 25° C., 30° C., 35° C., 40° C. and 45° C. The amount of liquid sample introduced into the measuring cell was approximately 2 mL.

A pycnometer is a simple instrument, used to accurately determine the density of solids, it is a glass container equipped with a ground stopper with a capillary tube, whose volume (Vpic) and mass (mpic) are known at a given temperature. To calculate the density, n-dodecane was used as the displacement liquid.

To calculate the density of the PCM, the procedure was as follows: the empty and covered pycnometer (mpic) was weighed, the pycnometer filled with n-dodecane was weighed and covered (mpic+n-dod), a known mass of the PCM, then capped and weighed (mpic+dod+PCM). To calculate the density of the PCM at temperature, I calculate the displaced volume based on the previous measurements and using the mass of n-dodecane and its density, and from the volume, the density of the PCM was calculated, knowing its mass and dividing by the volume calculated as indicated.

The expansion of the volume during the melting process of the mixtures must be considered for the encapsulation of the PCM and its implementation in the thermal energy storage system. To estimate these parameters, the densities of solid and liquid samples were extrapolated to the melting point, determining the value of the decrease in density due to a phase change (Shamberger P J, Reid T. Thermophysical Properties of Lithium Nitrate Trihydrate from (253 to 353) K. J Chem Eng Data 2012; 57 (5): 1404 1411. https://doi.org/10.1021/je3000469). The expansion was estimated as the ratio θV/Vsolid and is expressed as a percentage.

One quantity that is of primary importance is the energy storage density (esd) of the PCM, which is the ratio of specific latent heat to density. PCMs with esd values >200 MJ·m⁻³ are attractive because, due to a small change in temperature, they allow greater thermal energy storage than water, reducing costs. Therefore, it is imperative to know the density of any suggested PCM to assess its applicability for practical purposes (Minevich A, Marcus Y, Ben-Dor L. Densities of solid and molten salt hydrates and their mixtures and viscosities of the molten salts. J Chem Eng 2004; 49: 1451-1455. Https://doi.org/10.1021/je049849b). Energy storage density is calculated based on density and enthalpy. Total heat is also calculated based on enthalpy, the difference or range of operating temperature of the thermal energy system and thermal capacities of solid and liquid.

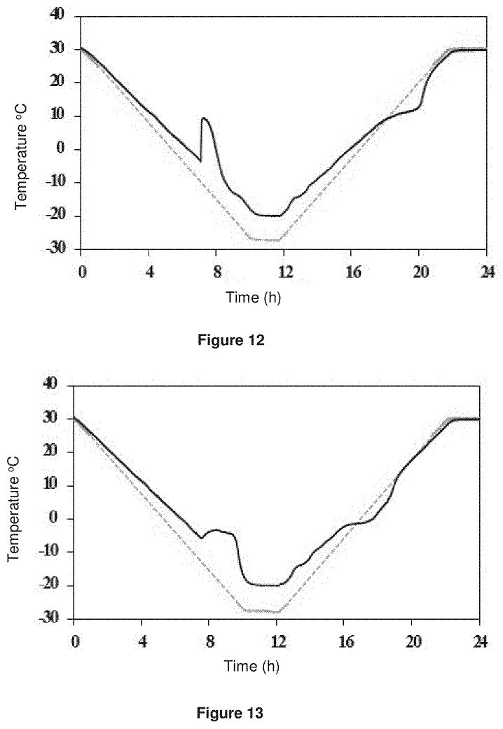

To the mixture LiNO₃—NaNO₃—Mn(NO₃)₂—H₂O, the experimental melting temperature was 10.8° C. and coincided with the value theoretically expected by the modified BET model and presented in the phase diagram (FIG. 2). The experimental results for the eutectic composition are shown in FIG. 12.

The quaternary mixture LiNO₃—NH₄NO₃—Mn(NO₃)₂—H₂O has a crystallization temperature of −3.1° C. and its melting temperature is −1.1° C., however the expected melting temperature is 3.4° C. The experimental results for the eutectic composition are shown in FIG. 13 defined in FIG. 3. The melting temperature is below the temperature range in which the solar-assisted AC system operates.

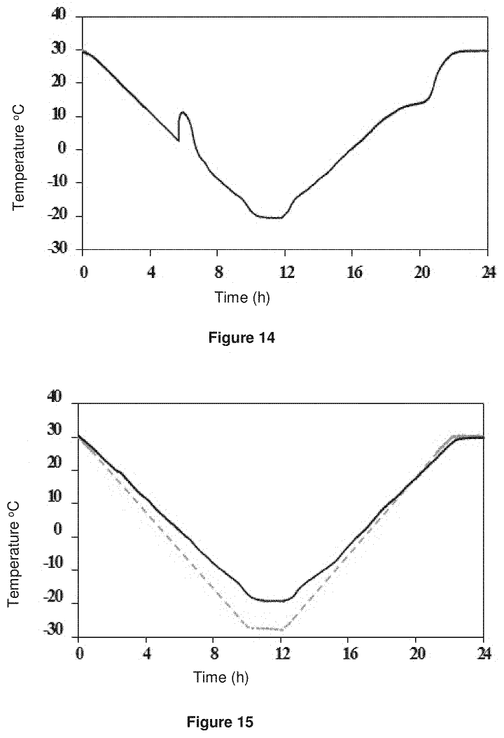

The measurement of the melting temperature for the mixture LiNO₃—Mn(NO₃)₂—Mg(NO₃)₂—H₂O gave a value of 13.1° C., 2.3° C. above the expected value shown in FIG. 4 The experimental results for the eutectic composition are shown in FIG. 14. Typical behavior is observed for the mixtures with the eutectic composition.

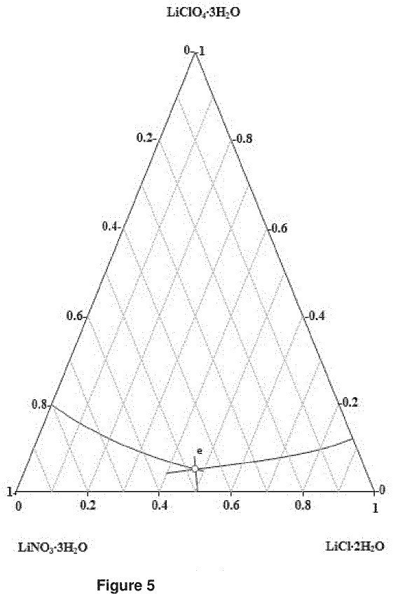

The LiCl—LiNO₃—LiClO₄—H₂O quaternary mixture does not show crystallization or melting in the temperature range −30 to 30° C. Therefore, it is not a candidate to be used as PCM in the temperature range studied, which is from 0 to 15° C. The expected melting temperature is 8.9° C. The experimental results for the composition modeled in FIG. 15 defined in FIG. 5 are shown.

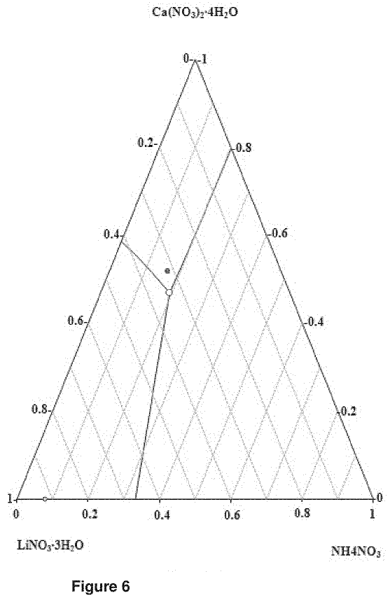

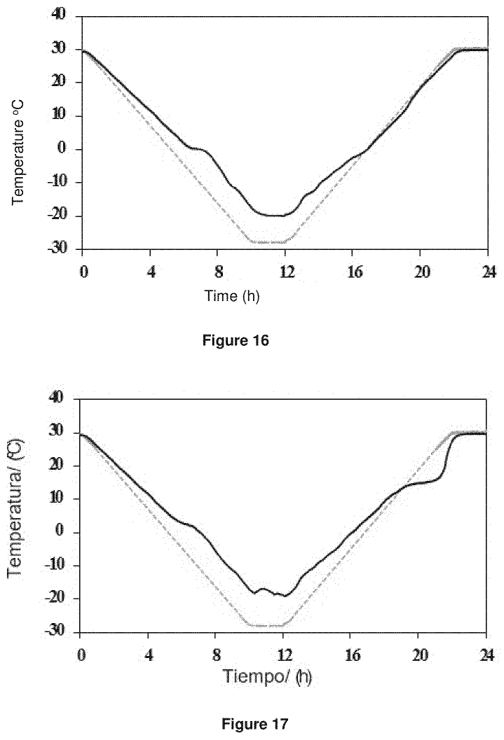

The quaternary mixture LiNO₃—NH₄NO₃—Ca(NO₃)₂—H₂O presents crystallization at 0.2° C. and irregular melting from −2.9° C. Therefore, it is not a candidate to be used as PCM in the temperature range studied, which is from 0 to 15° C. The predicted melting temperature is 7.9° C. Which is 10.9° C. higher than the experimental temperature. The experimental results for the composition modeled in FIG. 16 defined in FIG. 6 are shown.

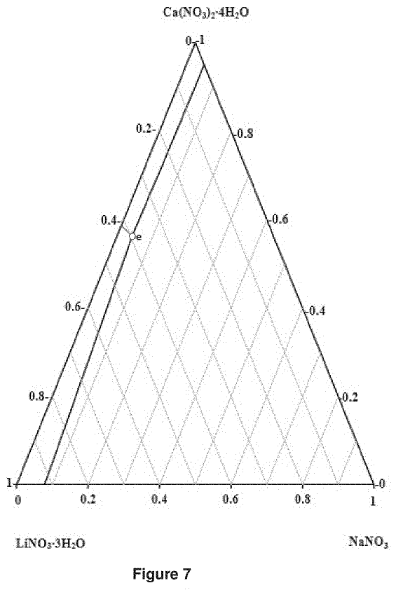

The quaternary mixture LiNO₃—NaNO₃—Ca(NO₃)₂—H₂O has a crystallization temperature of 2.4° C. and the melting temperature is 14.2° C. The temperature expected by the BET thermodynamic model, defined in FIG. 7, is 16.4° C., being 2.2° C. higher than that obtained experimentally. FIG. 17 shows that the composition of the mixture is not eutectic because it does not present a defined platform in crystallization.

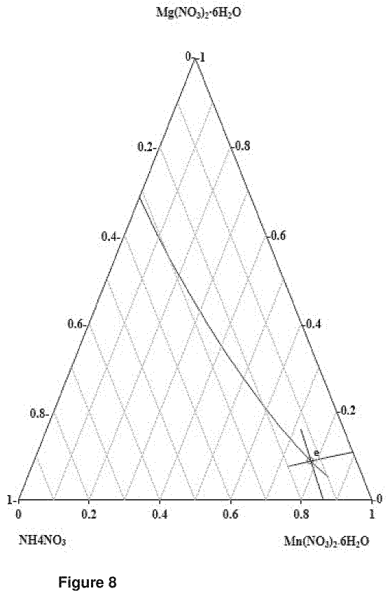

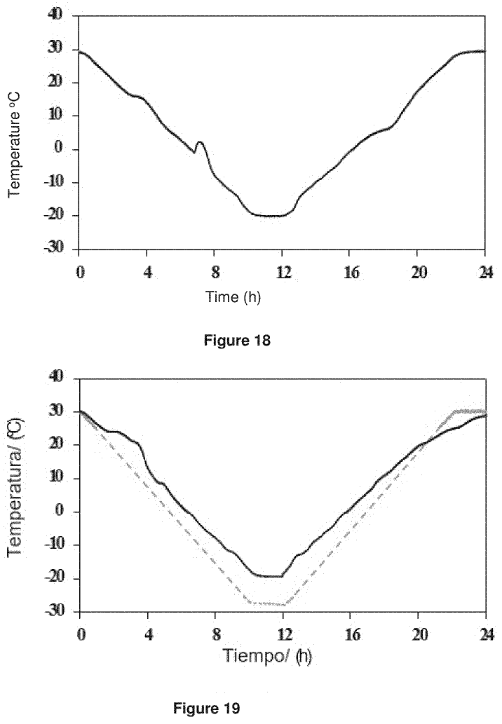

The NH₄NO₃—Mn(NO₃)₂—Mg(NO₃)₂—H₂O quaternary mixture has a crystallization temperature of 2.4° C. and the melting temperature is 6.2° C. The experimental results for the eutectic composition modeled in FIG. 18 are shown, where it can be seen that the platform that occurs both in crystallization and fusion are not defined and also, other signals are observed during crystallization and fusion. This indicates that the composition of the mixture does not correspond to a eutectic composition or there is probably a segregation of phases. The melting temperature defined in FIG. 8 is 13° C., 6.8° C. higher than that found experimentally.

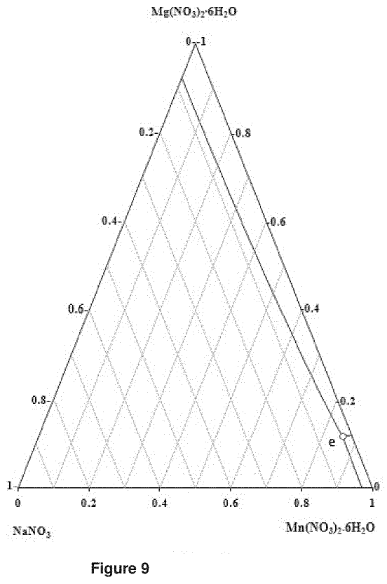

The experimental results for the modeled eutectic composition of the quaternary mixture NaNO₃—Mn(NO₃)₂—Mg(NO₃)₂—H₂O are shown in FIG. 19. The graph does not present a platform in crystallization, nor in melting. This indicates that the composition found by the modified BET model (FIG. 9) does not correspond to the eutectic composition.

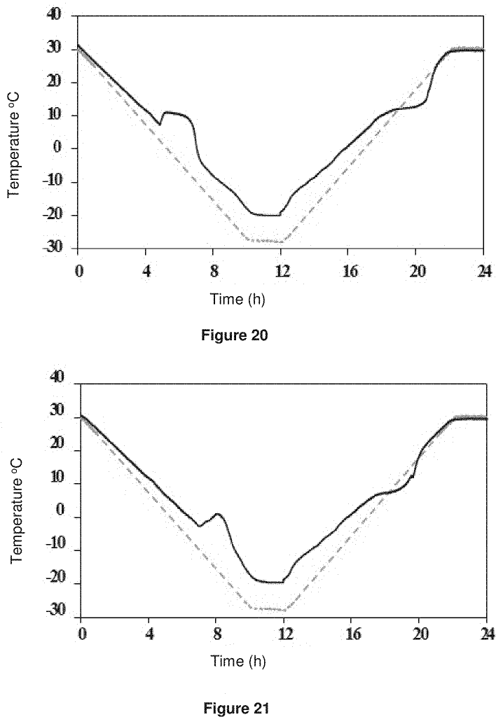

The quaternary mixture LiNO₃—NH₄NO₃—Mg(NO₃)₂—H₂O has the crystallization temperature of 10.9° C. and the melting temperature of 11.6° C. The temperature expected by the modified BET model is 13.6° C. (FIG. 10). The expected temperature is 2° C. higher than that obtained by experimentation. FIG. 20 shows that the mixture is eutectic. However, literature was found with the expected mixture LiNO₃—NH₄NO₃—Mg(NO₃)₂—H₂O quaternary mixture has a crystallization temperature of 10.9° C. and a melting temperature of 11.6° C. The temperature expected by the modified BET model is 13.6° C. (FIG. 10). The expected temperature is 2° C. higher than that obtained by experimentation. FIG. 20 shows that the mixture is eutectic. However, a bibliography was found with the expected mixture (Xia Y, Qi Yuan C, Wein-Lei W, De-Wen Z. Phase Diagram Prediction of the Quaternary System LiNO₃—Mg(NO₃)₂—NH₄NO₃—H₂O and Research of Related Phase Change Materials. Chinese J Inorg Chem 2012; 28(9):1873 1877).

The quaternary mixture LiNO₃—Mn(NO₃)₂—Ca(NO₃)₂—H₂O has the crystallization temperature equal to 0.4° C. and the melting temperature is 7.1° C. The temperature expected by the modified BET model is 5.7° C. (FIG. 11). The difference between the expected temperature and that obtained by the device shown in FIG. 1 is 1.4° C. FIG. 21 shows eutectic behavior.

In addition to experimentally verifying the results of the thermodynamic modeling, the nucleation temperature, Tnucl, and the presence of subcooling were determined, defined as the difference between the crystallization and nucleation temperatures, (ΔT_{sub}=Tcr−Tnucl). The values are summarized in Table 10.

TABLE 10
Summary of the experimental verification of the eutectic composition
and the phase change temperature for the ten quaternary mixtures.

| | Tf/ | Tcr/ | Tnucl/ | ΔTsub/ | Eutectic |
|---|---|---|---|---|---|
| Mixture | (° C.) | (° C.) | (° C.) | (° C.) | Composition |
| LiNO₃—NaNO₃—Mn(NO₃)₂—H₂O | 10.8 | 8.2 | 5.2 | 3.0 | Yes |
| LiNO₃—NH₄NO₃—Mn(NO₃)₂—H₂O | −1.1 | −3.1 | −5.7 | 2.7 | Yes |
| LiNO₃—Mn(NO₃)₂—Mg(NO₃)₂—H₂O | 13.1 | 10.0 | 2.5 | 7.5 | Yes |
| LiCl—LiNO₃—LiClO₄—H₂O | — | — | — | — | — |
| LiNO₃—NH₄NO₃—Ca(NO₃)₂—H₂O | −2.9 | 0.2 | 0.2 | 0 | — |
| LiNO₃—NaNO₃—Ca(NO₃)₂—H₂O | 14.25 | 2.4 | 2.4 | 0 | — |
| NH₄NO₃—Mn(NO₃)₂—Mg(NO₃)₂—H₂O | 6.2 | 2.4 | 1 | 1.4 | — |
| NaNO₃—Mn(NO₃)₂—Mg(NO₃)₂—H₂O | — | — | — | — | — |
| LiNO₃—NH₄NO₃—Mg(NO₃)₂—H₂O | 12.0 | 10.9 | 7.5 | 3.4 | Yes |
| LiNO₃—Mn(NO₃)₂—Ca(NO₃)₂—H₂O | 7.1 | 0.4 | −2.5 | 2.9 | Yes |

Subcooling is a serious problem associated with hydrated salts. One of the variables that affect nucleation is the sample size (Garcia-Romero A, Diarce G, Ibarretxe J, Urresti A, Sala J M. Influence of the experimental conditions on the subcooling of Glauber's salt when used as PCM. 94 Sol Energy Mater Sol Cells 2012; 102: 189-195. Https://doi.org/10.1016/j.solmat.2012.03.003). This method presented the subcooling corresponding to the sample size used, which was 12.5 g.

By verifying the modified BET model (see Table 9) of the ten quaternary mixtures, only five of them were shown to be suitable to be used as PCMs, LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O. The following physical and thermal property characterizations apply to the five most suitable mixtures to be used as PCMs.

The eutectic point of two quaternary mixtures proposed by the modified BET model were tested with compositions other than the expected eutectic point (e). The compositions of A, B and C of the mixtures LiNO₃—NaNO₃—Mn(NO₃)₂—H₂O and LiNO₃—Mn(NO₃)₂—Mg(NO₃)₂—H₂O is summarized in Table 11.

TABLE 11
Composition A, B and C of mixtures
LiNO₃—NaNO₃—Mn(NO₃)₂—H₂O
and LiNO₃—Mn(NO₃)₂—Mg(NO₃)₂—H₂O.

| | Mass relation | | |
|---|---|---|---|
| System | A | B | C |
| LiNO₃•3H₂O:NaNO₃:Mn(NO₃)₂•6H₂O | 22.1:10.0:67.9 | 18.1:1.8:80.1 | 36.0:2.5:61.5 |
| LiNO₃•3H₂O:Mn(NO₃)₂•6H₂O:Mg(NO₃)₂•6H₂O | 20.9:63.1:16.0 | 17.5:73.3:9.2 | 30.0:65.0:5.0 |

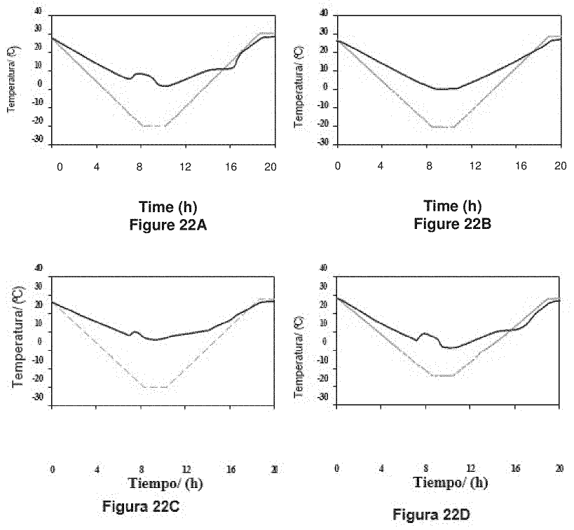

The exothermic and endothermic behavior of LiNO₃—NaNO₃—Mn (NO₃)₂—H₂O for the mixtures with the compositions of the eutectic point and points A, B and C is shown in FIG. 22. The repetition of the eutectic point was carried out to observe in detail the behavior of the mixture in a less wide temperature range.

Mixes with composition other than the expected point e (points A, B and C) practically lack the platform. The only exception is point C, which has a certain tendency to form the platform because it has the composition closest to the eutectic point compared to A and B. Therefore, it can be confirmed that the measured eutectic composition and melting temperature validate the expected value by the modified BET model.

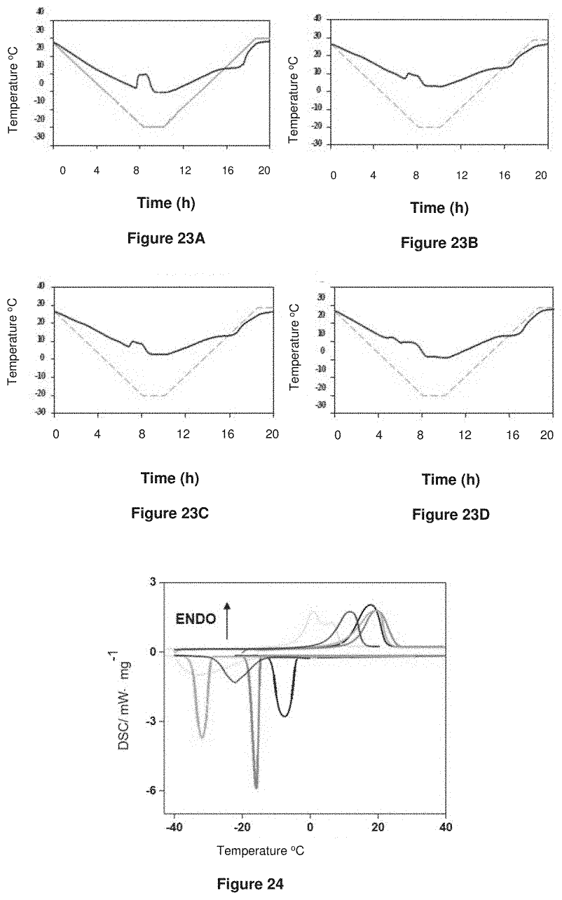

The exothermic and endothermic behavior of LiNO₃—Mn(NO₃)₂—Mg(NO₃)₂—H₂O was demonstrated for the mixtures with compositions A, B and C are presented in FIG. 23. The mixture with the highest nitrate content lithium (point C) does not have this characteristic. Mixtures A and B tend to form the platform and Mixture C exhibited an irregular phase change during the crystallization stage. Therefore, the eutectic point (e) and the melting temperature expected by the modified BET model are confirmed for this mixture.

The thermophysical characterization of the 5 PCMs is provided below. The properties of quaternary mixtures are related to the values of the reactants that participate in the system/mixture. Table 12 shows the properties of the reagents present in the systems/mixtures.

TABLE 12
Properties of reagents LiNO₃·3H₂O, NaNO₃, Mg(NO₃)₂ · 6H₂O, Mn(NO₃)₂ · 6H₂O
and some of its systems

| Hydrated | Tm/ | ΔHf/ | ρ/ | Cp/(J · g⁻¹ · | | |
|---|---|---|---|---|---|---|
| Salt | (° C.) | (kJ · kg⁻¹) | (g · cm⁻³) | K⁻¹) | η/(cP) | Source |
| LiNO₃•3H₂O | 30 | 296 | 1.610 (s, | 1.73 (s, | 4.80 | Shamberger PJ, Reid T. Thermophysical |
| | | | 22° C.) | 15° C.) | (40° C.) | Properties of Lithium Nitrate Trihydrate from |
| | | | 1.420 (I, | 2.76 (I, | | (253 to 353) K. J Chem Eng Data |
| | | | 40° C.) | 40° C.) | | 2012; 57(5): 1404-1411. |
| | | | | | | https://doi.org/10.1021/je3000469; Cabeza |
| | | | | | | LF, Castell A, Barrenechea C, Gracia A, |
| | | | | | | Fernández Al. Materials used as PCM in |
| | | | | | | thermal energy storage in buildings: A review. |
| | | | | | | Renew Sust Energ Rev 2011; 15: 1675-1695. |
| | | | | | | https://doi.org/10.1016/j.rser.2010.11.018 |
| NaNO₃ | 306 | 172 | 1.636 (s) | 1.38 (s, | — | Cabeza LF, Castell A, Barrenechea C, Gracia |
| | | | 1.550 (I) | 155° C.) | | A, Fernández Al. Materials used as PCM in |
| | | | | 1.67 (I, | | thermal energy storage in buildings: A review. |
| | | | | 312- | | Renew Sust Energ Rev 2011; 15: 1675-1695. |
| | | | | 377° C) | | https://doi.org/10.1016/j.rser.2010.11.018. |
| Mg(NO₃)₂• | 89.9 | 163 | 1.636 (s, | 1.636(s, | — | Cabeza LF, Castell A, Barrenechea C, |
| 6H₂O | | | 25° C.) | 25° C.) | | Gracia A, Fernández Al. Materials used as |
| | | | 1.550 (I, | 1.550(I, | | PCM in thermal energy storage in buildings: |
| | | | 94° C.) | 94° C.) | | A review. Renew Sust Energ Rev |
| | | | | | | 2011; 15: 1675-1695. |
| | | | | | | https://doi.org/10.1016/j.rser.2010.11.018. |
| Mn(NO₃)₂• | 37.1 | 115 | 1.738 (I, | — | — | Cabeza LF, Castell A, Barrenechea C, |
| 6H₂O | | | 20° C.) | | | Gracia A, Fernández Al. Materials used as |
| | | | | | | PCM in thermal energy storage in buildings: |
| | | | | | | A review. Renew Sust Energ Rev |
| | | | | | | 2011; 15: 1675-1695. |
| | | | | | | https://doi.org/10.1016/j.rser.2010.11.018. |
| LiCl | 610 | 441 | 2070 (s) | — | — | Alva G, Liu L, Huang X, Fang G. Thermal |
| | | | 1502 (I) | | | energy storage materials and systems for |
| | | | | | | solar energy applications. Renewable and |
| | | | | | | Sustainable Energy Reviews 2017; 68: 693- |
| | | | | | | 706. |
| | | | | | | https://doi.org/10.1016/j.rser.2016.10.021. |
| LiClO₃ | 8.1 | 253 | 1720 (s) | 2.88 (s) | — | Baumann H, Heckenkamp J. |
| 3H₂O | | 155 | 1530 (I) | | | Latentwärmespeicher. Nachrichten Aus |
| | | | | | | Chemie, Technik Und Laboratorium |
| | | | | | | 1997; 45(11): 1075-1081. |
| | | | | | | https://doi:10.1002/nadc.199700023 |
| NH₄NO₃ | 169.6 | — | 1.725 | — | — | Byju's the learning app |
| | | | | | | https://byjus.com/chemistry/ammonium-nitrate/2016 |
| | | | | | | [consultado 1 de octubre de 2019] |
| Ca(NO₃)₂• | 42.6 | 140 | 1.82 (s) | 1.46 (s) | — | Kenisarin M, Mahkamov K. Salt hydrates as |
| 4H₂O | | | | | | latent heat storage materials: |
| | | | | | | Thermophysical properties and costs. Sol |
| | | | | | | Energy Mater Sol Cells 2006; 145: 255-286. |
| | | | | | | https://doi:10.1016/j.solmat.2015.10.029 |

The heats of crystallization and fusion of mixtures LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O eutectic composition were measured by DSC and are listed in Table 13.

TABLE 13
Heats and temperatures of melting and crystallization of eutectic mixtures
measured in DSC.

| | | | Tcr/ | | | Tm/ | | |
|---|---|---|---|---|---|---|---|---|
| Eutectic composition | ΔHcrl | ΔHml | (° C.) | | | (° C.) | | |
| mixtures | (kJ · kg⁻¹) | (kJ · kg⁻¹) | Tinitial | Tpeak | Tfin | Tinicio | Tpeak | Tfin |
| LiNO₃—NaNO₃— | 157.7 | 172.5 | −4.2 | −7.5 | −11.4 | 108 | 17.7 | 22.0 |
| Mn(NO₃)₂—H₂O | | | | | | | | |
| LiNO₃—NH₄NO₃— | 136 | 169.8 | −42.2 | −31.3 | −25.9 | −3.5 | 0.8 | 9.3 |
| Mn(NO₃)₂—H₂O | | | | | | | | |
| LiNO₃—Mn(NO₃)₂— | 133.4 | 152.8 | −14.8 | −15.9 | −18.1 | 13.5 | 19.5 | 25.2 |
| Mg(NO₃)₂—H₂O | | | | | | | | |
| LiNO₃—NH₄NO₃— | 162.6 | 187.6 | −34.8 | −31.8 | −29.5 | 9.6 | 19.4 | 22.7 |
| Mg(NO₃)₂—H₂O | | | | | | | | |
| LiNO₃—Mn(NO₃)₂— | 107.6 | 142.2 | −28.2 | −22.2 | −14.2 | 4.6 | 11.5 | 15.4 |
| Ca(NO₃)₂—H₂O | | | | | | | | |

FIG. 24 presents the results of the five quaternary systems measured by DSC.

It is common to observe the presence of subcooling in PCMs that have hydrated salts or their mixtures. The 5 PCMs mentioned above present a subcooling, ΔT, estimated on the basis of DSC measurements, as the difference between melting and crystallization temperatures (Tpeak), of 25.2° C., 43.0° C., 35.4° C., 51.2° C. and 33.7° C. to LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O, respectively.

It is common to observe the presence of subcooling in PCMs that have hydrated salts or their mixtures. The 5 PCMs mentioned above present a subcooling, ΔT, estimated on the basis of DSC measurements, as the difference between the temper. However, these values are high, compared to the results shown in Table 10, a decrease in subcooling was observed by increasing the amount of material analyzed (12.5 g vs 15 mg). A similar subcooling reduction was presented in previous works, where bischophyte (95% MgCl₂H₂O) was characterized with DSC, T-history methods and on the pilot scale melting and crystallization saturations. (Ushak S, Gutierrez A, Galleguillos H, Fernandez A G, Cabeza L F, Grágeda M. Thermophysical characterization of a by-product from the non metallic industry as inorganic PCM. Sol Energy Mater Sol Cells 2015; 132: 385-391. https://doi.org/10.1016/1.solmat.2014.08.042; Rathgeber C, Schmit H, Mitt L, Cabeza L F, Gutierrez A, Ushak S N et al. Enthalpy-temperature plots to compare calorimetric measurements of phase change materials at different sample scales. Journal of Energy Storage 2018; 15:32-38. https://doi.org/10.1016/j.est.2017.11.002; Gasia J, Gutierrez A, Peiro G, Miro L, Grageda M, Ushak S et al. Thermal performance evaluation of bischofite at pilot plant scale. Applied Energy 2015; 155:826-833. https://doi.org/10.1016/j.apenergy.2015.06.042).

Latent heat storage is closely related to sensible heat storage. On the one hand, before materials reach the temperature of the phase change, they use sensible heat to store energy. On the other hand, due to the extremely low thermal conductivity of phase change materials, the temperature difference in the internal area of the materials is huge, which will lead to the fact that when some parts start the phase transformation, the others have not yet reached the transition temperature. Therefore, specific heat is crucial in real applications. (Chen Y Y, Zhao C Y. Thermophysical properties of Ca(NO₃)₂—NaNO₃—KNO₃ mixtures for heat transfer and thermal storage. Solar Energy 2017; 146:172-179. https://doi:10.1016/j.solener.2017.02.033).

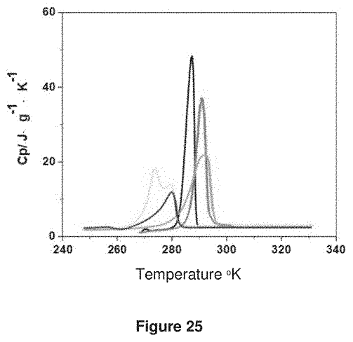

Based on the DSC the specific heat of the eutectic mixtures was measured. FIG. 25 shows the dependence of specific heat on temperature, where a sudden change in specific heat can be observed in the range of 280.0-290.0 K, 259.9-284.8 K, 280.1-302.6 K, 265.1-297.4 K and 261.9-284.3 K to mixtures of LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O. respectively. The shape of the curve is characteristic of materials exhibiting a phase change, confirming that it is a eutectic composition.

For solid samples, the specific heat shows an increase over a temperature range of 272.7 to 280.0 K with values of 1.538 to 2.379 J·g⁻¹·K⁻¹ to the mixture LiNO₃—NaNO₃—Mn(NO₃)₂—H₂O, the range of temperature 247.2 to 259.9 K with values of 2.001 to 2.166 J·g⁻¹·K⁻¹ to the mixture LiNO₃—NH₄NO₃—Mn(NO₃)₂—H₂O, the range of temperature 269.9 to 280.1 K of 1.227 to 2.038 J·g⁻¹·K⁻¹ to the mixture LiNO₃—Mn(NO₃)₂—Mg(NO₃)₂—H₂O, the range of temperature 250.5 to 265.1 K with values of 1.790 to 2.131 J·g⁻¹·K⁻¹ to the mixture LiNO₃—NH₄NO₃—Mg(NO₃)₂—H₂O and the range of temperature 247.8 to 261.9 K with values of 2.304 to 1.46 J·g⁻¹·K⁻¹ to the mixture LiNO₃—Mn(NO₃)₂—Ca(NO₃)₂—H₂O.

Specific heat values for the liquid phase in a temperature range from 290.0 to 302.1 K with values from 2.500 to 2.583 J·g⁻¹·K⁻¹ to LiNO₃—NaNO₃—Mn(NO₃)₂—H₂O, in a range of temperature from 284.8 to 330.0 K with values from 2,892 to 3,174 J·g⁻¹·K⁻¹ to the mixture LiNO₃—NH₄NO₃—Mn(NO₃)₂—H₂O, in a range of temperature from 302.6 to 320.0 K with values from 2.600 to 2.446 J·g⁻¹·K⁻¹ to LiNO₃—Mn(NO₃)₂—Mg(NO₃)₂—H₂O, in a range of temperature from 297.4 to 330.0 K with values from 2.961 to 2.585 J·g⁻¹·K⁻¹ to the mixture LiNO₃—NH₄NO₃—Mg(NO₃)₂—H₂O and in a range of temperature from 284.3 to 330.0 K with values from 2.536 to 2.441 J·g⁻¹·K⁻¹ to the mixture LiNO₃—Mn(NO₃)₂—Ca(NO₃)₂—H₂O. The adjustments of Cp solid is showed in Table 13.

TABLE 13
Adjustments of the quaternary eutectic mixtures is solid state.

| Quaternary systems | Cp/J · g⁻¹ · K⁻¹ |
|---|---|
| LiNO₃—NaNO₃—Mn(NO₃)₂—H₂O | y = −0.001x² + 0.6152x − 92.066; R² = 0.9675 |
| LiNO₃—NH₄NO₃—Mn(NO₃)₂—H₂O | y = 0.0057x² − 2.932x + 379.88; R² = 0.9956 |
| LiNO₃—Mn(NO₃)₂—Mg(NO₃)₂—H₂O | y = −0.0006x² + 0.3829x − 61.461; R² = 0.9881 |
| LiNO₃—NH₄NO₃—Mg(NO₃)₂—H₂O | y = 0.0003x² − 0.1391x + 17.017; R² = 0.9967 |
| LiNO₃—Mn(NO₃)₂—Ca(NO₃)₂—H₂O | y = 4 × 10⁻⁵x⁵ − 0.0492x⁴ + 24.984x³ − |
| | 6340.9x² + 804535x − 4 × 10⁷; R² = 0.9953 |

The dynamic viscosity of the five promising quaternary mixtures as PCMs is presented in Table 14.

TABLE 14
Dynamic viscosity of expected quaternary
mixtures of eutectic composition.

| Mixture | μ/cP |
|---|---|
| LiNO₃—NaNO₃—Mn(NO₃)₂—H₂O | 18.18 ± 0.02 |
| LiNO₃—NH₄NO₃—Mn(NO₃)₂—H₂O | 12.30 ± 0.25 |
| LiNO₃—Mn(NO₃)₂—Mg(NO₃)₂—H₂O | 18.15 ± 0.16 |
| LiNO₃—NH₄NO₃—Mg(NO₃)₂—H₂O | 11.45 ± 0.23 |
| LiNO₃—Mn(NO₃)₂—Ca(NO₃)₂—H₂O | 21.43 ± 0.23 |

The solid phase density of the quaternary eutectic mixtures was measured at 0° C., with the exception of LiNO₃—NH₄NO₃—Mn(NO₃)₂—H₂O which was measured at −5° C. and the liquid phase was measured at 25, 30, 35, 40 and 45° C. to the five quaternary eutectic mixtures. The results obtained are showed in Table 15.

TABLE 15
Densities (+std) of mixtures with eutectic composition.

| Mixtures | T/(° C.) | ρ/(g · cm⁻³) | Phase |
|---|---|---|---|
| LiNO₃—NaNO₃—Mn(NO₃)₂—H₂O | 0 | 1.753 ± 2.1 × 10⁻² | Solid |
| | 25 | 1.65455 ± 0.3x × 10⁻⁴ | Liquid |
| | 30 | 1.65212 ± 0.3 × 10⁻⁴ | |
| | 35 | 1.64769 ± 0.3 × 10⁻⁴ | |
| | 40 | 1.64328 ± 0.4 × 10⁻⁴ | |
| | 45 | 1.63891 ± 0.4 × 10⁻⁴ | |
| LiNO₃—NH₄NO₃—Mn(NO₃)₂—H₂O | −5 | 1.641 ± 0.9 × 10⁻² | Solid |
| | 25 | 1.60102 ± 3.2 × 10⁻⁴ | Liquid |
| | 30 | 1.59156 ± 8.4 × 10⁻⁴ | |
| | 35 | 1.58608 ± 0.1 × 10⁻⁴ | |
| | 40 | 1.58274 ± 0.9 × 10⁻⁴ | |
| | 45 | 1.57107 ± 0.1 × 10⁻⁴ | |
| LiNO₃—Mn(NO₃)₂—Mg(NO₃)₂—H₂O | 0 | 1.679 ± 1.4 × 10⁻² | Solid |
| | 25 | 1.63472 ± 7.9 × 10⁻⁴ | Liquid |
| | 30 | 1.63441 ± 0.1 × 10⁻⁴ | |
| | 35 | 1.63010 ± 0.4 × 10⁻⁴ | |
| | 40 | 1.62568 ± 0.3 × 10⁻⁴ | |
| | 45 | 1.62144 ± 0.1 × 10⁻⁴ | |
| LiNO₃—NH₄NO₃—Mg(NO₃)₂—H₂O | 0 | 1.623 ± 8.3 × 10⁻² | Solid |
| | 25 | 1.48125 ± 2.5 × 10⁻⁴ | Liquid |
| | 30 | 1.47869 ± 5.0 × 10⁻⁴ | |
| | 35 | 1.47493 ± 2.0 × 10⁻⁴ | |
| | 40 | 1.47324 ± 0.1 × 10⁻⁴ | |
| | 45 | 1.46923 ± 2.5 × 10⁻⁴ | |
| LiNO₃—Mn(NO₃)₂—Ca(NO₃)₂—H₂O | 0 | 1.676 ± 8.0 × 10⁻² | Solid |
| | 25 | 1.63005 ± 8.5 × 10⁻⁴ | Liquid |
| | 30 | 1.62851 ± 0.1 × 10⁻⁴ | |
| | 35 | 1.62356 ± 7.8 × 10⁻⁴ | |
| | 40 | 1.61634 ± 0.1 × 10⁻⁴ | |
| | 45 | 1.61306 ± 6.2 × 10⁻⁴ | |

The density data in the liquid state in the temperature range from 20° C. to 45° C. are fitted as a linear function of temperature and are represented by the following linear relationships respectively:

LiNO₃—NaNO₃—Mn(NO₃)₂—H₂O, ρ/l (g·cm⁻³)=−0.0011T+1.686

LiNO₃—NH₄NO₃—Mn(NO₃)₂—H₂O, ρ/l (g·cm⁻³)=−0.0012T+1.6238

LiNO₃—Mn(NO₃)₂—Mg(NO₃)₂—H₂O, ρ/l (g·cm⁻³)=−0.0008T+1.6575

LiNO₃—NH₄NO₃—Mg(NO₃)₂—H₂O, y ρ/l (g·cm⁻³)=−0.0006T+1.4943

LiNO₃—Mn(NO₃)₂—Ca(NO₃)₂—H₂O, ρ/l (g·cm⁻³)=−0.0012T+1.6571

Volume expansion during melting of mixtures LiNO₃—NaNO₃—Mn(NO₃)₂—H₂O, LiNO₃—NH₄NO₃—Mn(NO₃)₂—H₂O, LiNO₃—Mn(NO₃)₂—Mg(NO₃)₂—H₂O, LiNO₃—NH₄NO₃—Mg(NO₃)₂—H₂O and LiNO₃—Mn(NO₃)₂—Ca(NO₃)₂—H₂O was ΔV/Vsolid=4.9%, 4.2%, 2.1%, 2.0% and 0.4%, respectively. Such values were similar to the established ones to salt hydrates or mixtures (Minevich A, Marcus Y, Ben-Dor L. Densities of solid and molten salt hydrates and their mixtures and viscosities of the molten salts. J Chem Eng 2004; 49:1451-1455. https://doi.org/10.1021/je049849b).

The design and thermophysical characterizations of the five mixtures were carried out to be applied in water storage tanks coupled to a solar-assisted AC system installed in a building. The melting temperatures of the 5 mixtures were adequate to achieve the operation of the chilled water storage tanks at a temperature between 0 and 15° C., with the exception of LiNO₃—NH₄NO₃—Mn(NO₃)₂—H₂O whose melting temperature is lower than the desired temperature range.

When designing a material for TES, it is important to know its properties and storage costs. In this sense, the calculation of the total heat was carried out. The results are presented in Table 16 for each of the 5 mixtures, which were compared with four commercial mixtures at similar melting temperatures, obtaining values close to those of their commercial competitors.

TABLE 16
Stored energy

| Mixtures having | T/ | ρ/ | ΔH/kJ · | Cp/J · | Q total/ | esd/ |
|---|---|---|---|---|---|---|
| eutectic composition | ° C. | g · cm⁻³ | kg⁻¹ | g⁻¹ · K⁻¹ | kJ · kg⁻¹ | MJ · m⁻³ |
| LiNO₃—NaNO₃—Mn(NO₃)₂— | 10.8 | 1.753 | 157.7 (cr) | 1.538 (s, | 199.6 | 302.4 |
| H₂O | | | 172.5 (m) | 272.7 K) | | |
| | | | | 2.489 (I, | | |
| | | | | 290.0 K) | | |
| LiNO₃—NH₄NO₃—Mn(NO₃)₂— | −1.1 | 1.641 | 136.0 (cr) | 2.166 (s, | 228.8 | 278.6 |
| H₂O | | | 169.8 (m) | 259.9 K) | | |
| | | | | 3.174 | | |
| | | | | (I, 330 K) | | |
| LiNO₃—Mn(NO₃)₂—Mg(NO₃)₂— | 13.1 | 1.679 | 133.4 (cr) | 1.227 (s, | 173.8 | 256.6 |
| H₂O | | | 152.8 (m) | 269.9 K) | | |
| | | | | 2.600 (I, | | |
| | | | | 302.6 K) | | |
| LiNO₃—NH₄NO₃—Mg(NO₃)₂— | 12.0 | 1.623 | 162.6 (cr) | 2.131 (s, | 222.1 | 304.5 |
| H₂O | | | 187.6 (m) | 265.1 K) | | |
| | | | | 2.961 (I, | | |
| | | | | 297.4 K) | | |
| LiNO₃—Mn(NO₃)₂—Ca(NO₃)₂— | 7.1 | 1.676 | 107.6 | 1.946 (s, | 175.3 | 238.3 |
| H2O | | | (cr) | 261.9 K) | | |
| | | | 142.2 | 2.441 | | |
| | | | (m) | (I, 330 K) | | |
| S8 (Commercial, | 8 | 1.475 | 130 | 1.90 | 158.5 | 191.8 |
| PCM Products Ltd) | | | | | | |
| S10 (Commercial, | 10 | 1.470 | 170 | 1.90 | 198.5 | 249.9 |
| PCM Products Ltd) | | | | | | |
| S13 (Commercial, | 13 | 1.515 | 150 | 1.90 | 178.5 | 227.3 |
| PCM Products Ltd) | | | | | | |
| ClimSel C10 | 11 | 1.4 | 116 | — | — | 162.4 |

1. Method for preparing a quaternary eutectic salt LiNO₃—NaNO₃—Mn(NO₃)₂—H₂O comprising mixing LiNO₃.3H₂O:NaNO₃:Mn(NO₃)₂.6H₂O at a mass ratio 24.2:3.0:72.8 into water, adding firstly LiNO₃.3H₂O into water, then NaNO₃ and after Mn(NO₃)₂.6H₂O under constant stirring and at a temperature of 30° C. up to achieving a total dissolution and then allowing the salt formation.

2. A quaternary eutectic salt LiNO₃—NaNO₃—Mn(NO₃)₂—H₂O prepared by the method of claim 1.

3. Use of the salt of claim 2 as phase changing material (PCM) to short-term thermal storing units in a solar cooling/heating system.

4. Method for preparing a quaternary eutectic salt LiNO₃—NH₄NO₃—Mn(NO₃)₂—H₂O comprising mixing LiNO₃.3H₂O:NH₄NO₃:Mn(NO₃)₂.6H₂O at a mass ratio 21.4:13.9:64.7 into water, firstly adding LiNO₃.3H₂O into water, then NH₄NO₃ and after Mn(NO₃)₂.6H₂O under constant stirring and at a temperature of 30° C. up to achieving total dissolution and then allowing the salt formation.

5. A quaternary eutectic salt LiNO₃—NH₄NO₃—Mn(NO₃)₂—H₂O prepared by the method of claim 4.

6. Use of the salt of claim 5 as phase changing material (PCM) to short-term thermal storing units in a solar cooling/heating system.

7. Method for preparing a quaternary eutectic LiNO₃—Mn(NO₃)₂—Mg(NO₃)₂—H₂O comprising mixing LiNO₃.3H₂O:Mn(NO₃)₂.6H₂O:Mg(NO₃)₂.6H₂O at a mass ratio 22.9:68.6:8.5 into water, adding firstly LiNO₃.3H₂O into water, then Mn(NO₃)₂.6H₂O and after Mg(NO₃)₂.6H₂O under constant stirring and at a temperature of 30° C. up to achieving total dissolution and then allowing the salt formation.

8. A quaternary eutectic salt LiNO₃—Mn(NO₃)₂—Mg(NO₃)₂—H₂O prepared by the method of claim 7.

9. Use of the salt of claim 8 as phase changing (PCM) to short-term thermal storing units in a solar cooling/heating system.

10. Method for preparing a quaternary eutectic salt LiNO₃—NH₄NO₃—Mg(NO₃)₂—H₂O comprising mixing LiNO₃.3H₂O:NH₄NO₃:Mg(NO₃)₂.6H₂O at a mass ratio 55.8:27.8:16.4 into water, adding firstly LiNO₃.3H₂O into water, then NH₄NO₃ and after Mg(NO₃)₂.6H₂O under constant stirring and at a temperature of 30° C. up to achieving total dissolution and then allowing the salt formation.

11. A quaternary eutectic salt LiNO₃—NH₄NO₃—Mg(NO₃)₂—H₂O prepared by the method of claim 10.

12. Use of the salt of claim 11 as phase changing material (PCM) to short-term thermal storing units in a solar cooling/heating system.

13. Method for preparing a quaternary eutectic salt LiNO₃—Mn(NO₃)₂—Ca(NO₃)₂—H₂O comprising mixing LiNO₃.3H₂O:Mn(NO₃)₂.6H₂O:Ca(NO₃)₂.4H₂O at a mass ratio 17.7:55.3:27.0 into water, adding firstly LiNO₃.3H₂O into water, then Mn(NO₃)₂.6H₂O and after Ca(NO₃)₂.4H₂O under constant stirring and at a temperature of 30° C. up to achieving total dissolution, and the allowing the salt formation.

14. A quaternary eutectic salt prepared by the method of claim 13.

15. Use of the salt of claim as phase changing material (PCM) to short-term thermal storing units in a solar cooling/heating system.
